(19) United States
(12) Patent Application Publication
(10) Pub. No.: US 2014/0236745 A1
(43) Pub. Date: Aug. 21, 2014

(54) VIRTUALIZED DISTRIBUTION SYSTEM OFFERING VIRTUAL PRODUCTS OR SERVICES

(71) Applicant: AIRVM INC., Kanata (CA)

(72) Inventor: Joshua Vautour, Ottawa (CA)

(73) Assignee: AIRVM INC., Kanata (CA)

(21) Appl. No.: 13/771,755

(22) Filed: Feb. 20, 2013

(51) Int. Cl. G06Q 30/06

(52) U.S. Cl. CPC G06Q 30/0601
USPC 705/26.1

(57) ABSTRACT

In a virtualized distribution system for offering virtual products or services to clients over a distributed network a service provider manages physical resources. One or more orchestration servers having access to the physical resources run cloud management software that maintain a service providers portal to permit the service provider to manage the physical resources and accounts for distribution partners, a partner portal to permit the distribution partners to create virtual products or services using the available physical resources and establish a virtual presence on said distributed network, and a client portal for offering to clients the virtual products or services created by the distribution partners through their virtual presence. In this way product distribution can be offered as a service, which emulates the manner in which real products and services are distributed through a traditional distribution chain.

### FIELD OF THE INVENTION

This invention relates generally to the field of cloud computing, and in particular to a system and method for offering virtual products or services to clients over a distributed network, such as the Internet.

### BACKGROUND OF THE INVENTION

Cloud-based computing has enabled the rapid and scalable deployment of applications and services for use by third parties. A cloud-based architecture is typically made up of a set of physical resources such as processors, storage space, operating systems, software and other components that can be configured to instantiate a virtual machine, which behaves to the end user like a real machine. However, unlike a real machine the virtual hardware component, such as amount of RAM etc. are configurable. An example of a virtual machine is VMware, which allows virtual computers to be created within larger computers or networks of computers. The physical resources are typically owned and managed by a service provider, typically a telecom provider, who has no expertise in product distribution.

A reseller or service vendor of an application or service may wish to buy an instantiation of a provisioned virtual machine, or set of machines from a service provider. This virtual machine incorporates specific resources from a central system to perform intended tasks or run specific services or applications. For example, a service vendor may wish to resell well-known software such as Microsoft Office. The service vendor can lease or subscribe to a set of cloud resources from a service provider needed to run the instantiated virtual machine(s) and provide the necessary functions to resell the software. The instantiated machine appears to the end user as if it were a real computer or server.

Deployment of the software to resell to a third party requires many steps. First the service vendor must provision the cloud infrastructure. They must create a virtual machine or machines with boundary conditions that cover the use of I/O (Input/Output), storage, MIPS (Million Instructions Per Second) and choose the OS (Operating System) for the machine to run.

Next the service vendor has to log onto the system load and configure the application or service and decide which machine(s) it runs on.

The third step is to configure and build the OSS/BSS (Operating Support System/Business Support System). OSS is software applications that support back-office activities that provision and maintain customer services. Software applications that support customer-facing activities like billing, order management, and credit card processing, are all examples of BSS applications. Configuring and building these systems for a service vendor allows a third party (an ISV (Independent Software Vendor), reseller or end user) to have access to the application or service.

These systems use existing applications that the service vendor must choose and link together manually. They also have to do their own branding for the offered application or service, for example, to create the web page serving as a storefront. This is a time consuming and costly step. Unless specifically configured, the hardware that the application or service runs on is not dedicated, and the service vendor has no completely guaranteed SLA (Service Level Agreement).

Finally, the system is brought online and the third party is given access under the OSS/BSS constraints programmed by the service vendor.

A major concern for service vendors is how to price the service or application that they are offering. Costs come from many areas: amount of I/O, amount of storage, number of MIPS, application or service license cost, software used for OSS and BSS and corresponding license fees, time and understanding how to configure the system, time and understanding of mapping the OSS/BSS services to the application or service, and support and maintenance of the application or service and environment. Once the service vendor has the BOM (Bill of Materials) and knows the final price for all of the above, they need to add a sales margin.

One of the challenges for the growing number of Infrastructure Service (IAAS) providers is to differentiate from their competition. At its roots the base offer of IAAS is price competition, meaning their offer is “commodity” that the customer can source on demand and freely move between IAAS Providers with low costs and few barriers. In order to compete IAAS will move up the solution stack with differentiated service offerings. To do so the IAAS provider will require a solution set that has the following characteristics:
1. Be flexible to allow mixing of infrastructure such as computing power, storage and bandwidth (input/output) to be bundled with third party application software that solves a single business problem.
2. The resultant bundles when combined offer a complete Stack of Business to the IAAS channel and end customers (for example solve all of the back office requirements for security, reliability, storage, virus protection and usability for email communications).
3. The IAAS will need flexibility on how to price the bundles as a single point solution or complete stack of business including the ability to, in real time, model the cost associated with delivery of the solution and apply a consistent margin throughout their supply chain to the end consumer (e.g. distributor, reseller client/user).
4. The IAAS offering will require integration with existing billing and support systems to automate provisioning, procurement and Service Level Agreements driving customer support through the supply value chain (e.g. distributor, reseller client/user).

Currently a customer who sells real products or services to the public via a website using physical devices will purchase these from a hardware vendor. If a customer wishes to change the capacity of a server, the customer would have to approach the hardware vendor and order a replacement machine or upgrade hardware. Virtual servers allow for a customer to change the “size” of the machine without having to throw the old one away. While service providers have the resources available to create these virtual servers, they do not have the channel to market that hardware vendors do. It would be desirable for hardware vendor with whom the customer currently deals to have the ability to offer the virtual server as well. It is much easier for the customer to buy from them.

### SUMMARY OF THE INVENTION

Embodiments of the invention help to connect the service providers to the end customers (known as clients) through a chain of service vendors (known as partners or distribution partners), while providing the necessary tools to facilitate the management and billing for these virtual resources up the supply chain. Customers offering goods and services to the public can obtain the virtual server that they need from the distribution partners, who can offer a range of virtual products and services including billing and branding options to the customers. The customers in turn can present a storefront to the public offering their wares, which may be real goods and services, using the virtual facilities they have purchased.

According to the present invention there is provided a virtualized distribution system for offering virtual products or services to clients over a distributed network, comprising:

physical resources managed by a service provider; and

an orchestration server having access to the physical resources and being configured to run cloud management software to:
(i) maintain a service provider portal to permit the service provider to manage the physical resources and accounts for partners,
(ii) maintain a partner portal to permit the partners to create virtual products or services using the available physical resources and establish a virtual presence on said distributed network, and
(iii) maintain a client portal for offering to clients the virtual products or services created by the distribution partners through their virtual presence

The physical resources, which may be distributed over the network, may include storage devices, processors, physical servers etc.

The distribution partners may have accounts with the service provider that are created through the service provider portal. In the alternative it is possible to set up the partner portal so that aspiring partners may set up new accounts in much the same way as a customer might today set up a new account on a website.

Embodiments of the invention thus let service vendors who have virtual resources that they want to sell at the top level create a distribution channel in one or more tiers to make this easier for the service provider. Each tier is a sales channel. This lets the service provider offload the management of the channel, as each tier is responsible for the one above it (the service provider being at the bottom). For example, they can create a distributor tier, allocate virtual resources to them, and then they in turn can create many service vendors, which take the virtual resources and bundle them. The service vendor then creates and manages clients who consume the bundled resources.

The invention is similar to a distribution chain in the physical world. For example, whereas currently a retailer (client) might purchase hardware from a manufacturer or distributor and sell it through a website running on a physical server owned by the retailer, in the virtual world envisaged, the manufacturer is replaced by the service provider who owns or manages physical hardware out of which virtual resources can be created.

When the distribution partner wishes to create an account with the service vendor, it contacts the service provider (or more senior partner in the case of a tiered distribution chain) who sets up an account giving the partner access to the system through the partner portal. The partner can then create virtual products or services it wishes to offer through the partner portal. The virtual products may be, for example, virtual machines running on the physical resources managed by the service provider. For example, the distribution partner might offer a virtual server with a particular memory configuration etc.

The partner may also use the partner portal to create a branded storefront that appears to clients as a customized storefront through the client portal offering the virtual goods and services created by the partner and running on the physical resources managed by the service provider.

Clients of the distribution partner may then purchase the virtual goods or services through the client portal. A client entering the URL associated with a particular distribution partner will be taken to the common client portal, where it will be presented with the customized web page associated with the distribution partner and given the option to log on to an account or potentially also open a new one.

Once logged on to its account through the client portal the client may purchase virtual goods or services, such as virtual servers from a range of options created by the distribution partner through the partner portal. The client may then use the purchased goods or services to run its own software to offer real goods or services to the public in much the same way as if it had purchased the hardware from the distribution partner. The invention is not concerned with how the clients may ultimately use of the virtual goods or services purchased from the partners.

The virtual presence, which may be in the form of a web page, appears to the client as if it is running on a conventional server owned by the distribution partner although in practice it is a common portal shared with many other partners each having their own web page. Multiple addresses corresponding to different clients will point to the same client portal, but will display the web page associated with the entered address.

The partners may be organized in hierarchical tiers, whereby senior partners can create portals for junior partners and ultimately the clients in the hierarchy. The senior partners can set the environment for the more junior partners.

The available resources may be implemented as instantiations of virtual machines within the network. Embodiments of the invention thus allow a potential partner to subscribe to the service and set up a customized presence on the client portal simply by entering appropriate data through the partner's portal.

In periods of high demand, a customer may log on to its account and reconfigure its virtual server to increase capacity on payment of an additional premium. For example, the customer may choose to add more memory or otherwise increase the power of the server as if he were upgrading physical equipment. In periods of reduced demand, the same process can be used to reduce the power of the server, with a consequential reduction in costs.

Embodiments of the invention offer the ability to set virtual resources through a web-interface and tailor them to specific downstream (junior partner or client) needs. The user can simply login to a website to configure a server, for example, both in terms of its physical (albeit virtualized) structure, and the software it runs, taking advantage of commercial modules, such as payment systems and the like already available on the web.

The invention is very flexible and eliminates much of the manual configuration required in the prior art. The software is capable of automatically handling the pricing of the services offered to the partners based on the requested configuration.

### BRIEF DESCRIPTION OF THE DRAWINGS

The invention will now be described in more detail, by way of example only, with reference to the accompanying drawings, in which:

FIG. 1a shows the tiers of the system.

FIG. 1b shows a possible arrangement of servers connected via the LAN or WAN running software to manage the system or provide services to the system;

FIG. 2 shows the cloud management software in more detail;

FIG. 3 illustrates the job/task management software in more detail;

FIG. 4 illustrates the notification management software in more detail;

FIG. 5 illustrates the billing management software in more detail;

FIG. 6 illustrates the web application software in more detail;

FIGS. 7 to 34 show a sequence of possible user interfaces that show the process of creating a new partner, allowing them access to the system, and then having them create a new client, and some of the screens associated with managing the new client.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

Service providers have virtual resources that they wish to sell to a client through a sales channel. Embodiments of the invention provide a means of distributing these resources to clients through a business stack that is not available in the prior art. The embodiment provides a method by which a service provider can offer to partners a means to create a cloud based product or service with much greater ease and much less knowledge of the underlying systems. The service can be offered multiple partners, organized in tiers.

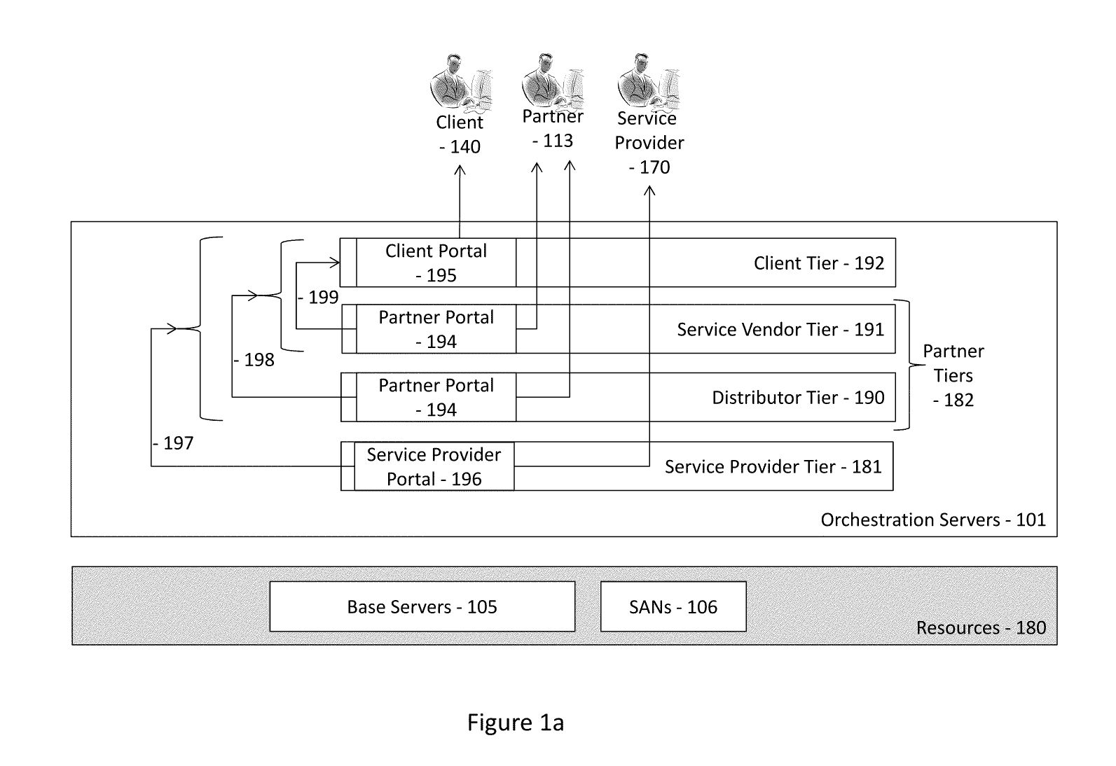

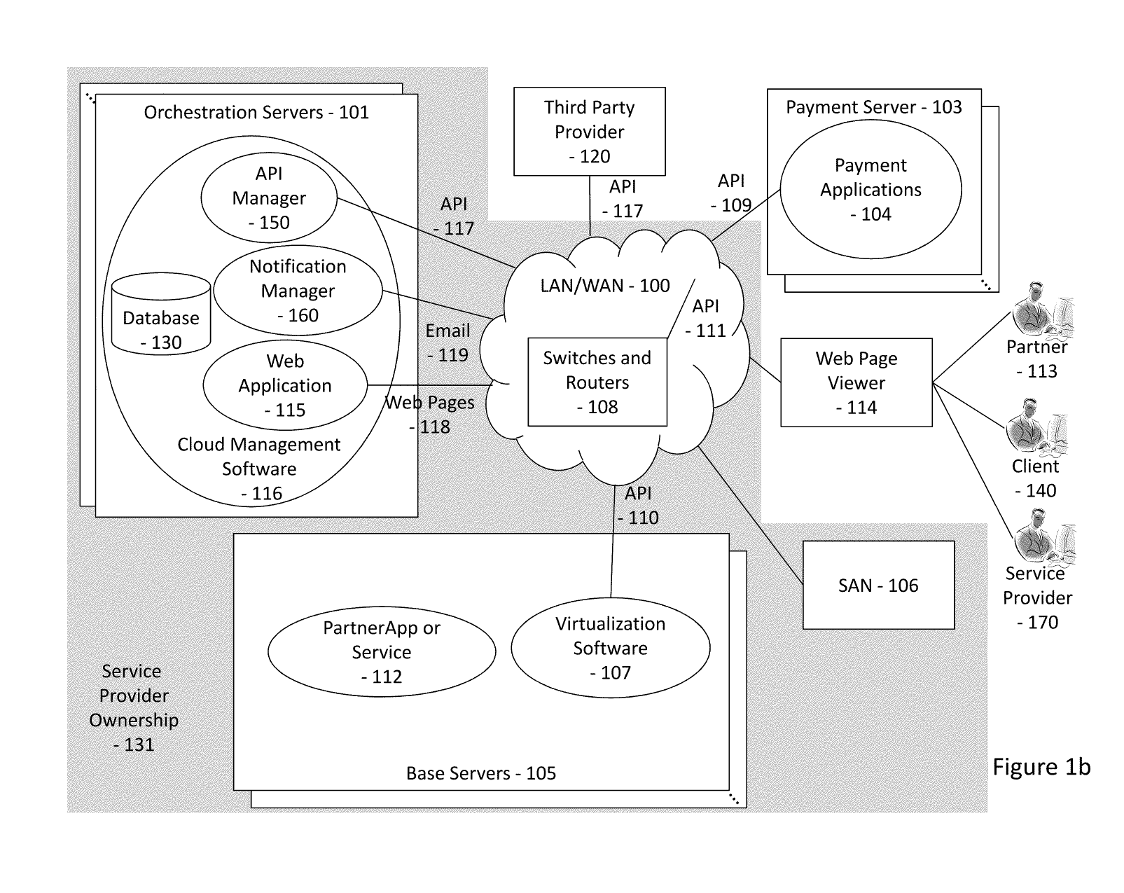

Referring to FIG. 1a, a service provider 170 has resources 180 which includes base servers 105 and SANs (Storage Area Networks) 106. The service provider wants to provide these resources 180 to partners 113, arranged in tiers, so as to allow the partners 113 to provide services to the tier above them. The final tier is the client tier 192, which provides products or services to clients 140.

The service provider 170 has orchestration servers 101 to host the software and to manage this. The tiers between the service provider tier 181 and the client tier 192 are known as partner tiers 182. The example given here shows the service provider tier 181, and two partner tiers 182, the distributor tier 190, the service vendor tier 191, and the client tier 192. Each tier has a portal that lets the appropriate user configure the tiers above it using various web pages. In this example, the service provider portal 196 can create and manage 197 the distributor tier 190, the service vendor tier 191 and the client tier 192. The partner portal 194 for the distribution tier 190 can create and manage 198 the service vendor tier 191 and the client tier 192. The partner portal 194 for the service vendor tier 191 can create and manage the client tier 192.

Referring to FIG. 1b, there is a LAN/WAN 100 made up of switches and routers 108 which provide an API 111 that lets software gather statistics like traffic usage, and allows for network and IP configurations for service vendors Attached to the LAN/WAN 100 are one or more orchestration servers 101 which hold the cloud management software module 116, the entity responsible for implementing this embodiment of the invention.

Within the cloud management software module 116, there is database 130 for holding many forms of information and the web application 115, which is responsible for providing web pages 118 to the web page viewer 114. The cloud management software module communicates with the switches and routers using API 111, the payment applications 104 using API 109 and the virtualization software 107 (for example VMWare™) via API 110 and third party providers 120 using API 117.

The cloud management software module 116 is also responsible for providing various (programmable) notifications to service vendors 113 via for example email 119. Other forms of communication could also be used like SMS or twitter. Its uses notification manger 160 to do this. The web application 115 manages the web pages 118 in the web page viewer 114 in a standard way. Also connected to the LAN/WAN 100 are base servers 105, which run virtualization software 107.

The cloud management software module 116 communicates with the virtualization software via API 110. The virtualization software 107 also manages the SAN (Storage Area Network) 106 through API 110. The partner app or service 112 resides on the base server 105 using the virtualization software 107 to run. Service vendor 113 uses web page viewer 114 which communicate in a standard way with web application 115 to set up and deploy the partner app or service 112 to clients 140. Clients 140 use a web page viewer 114, which communicates in a standard way with web application 115 to buy apps or services 112 from the partner 113. Attached to the LAN/WAN 100 are one or more payment servers 103 containing payment applications 104.

The cloud management software module 116 communicates using an API 109 with the payment applications 104. A third party provider 120 may use API 117 to access all the functionality provided by the cloud management software 116 that a partner 113 has access to via the web page viewer 114. API manager 150 handles this. The service provider has ownership 131 of the orchestration servers 101, the base servers 105, the SAN 106 and parts of the LAN/WAN 100 and switches and routers 108.

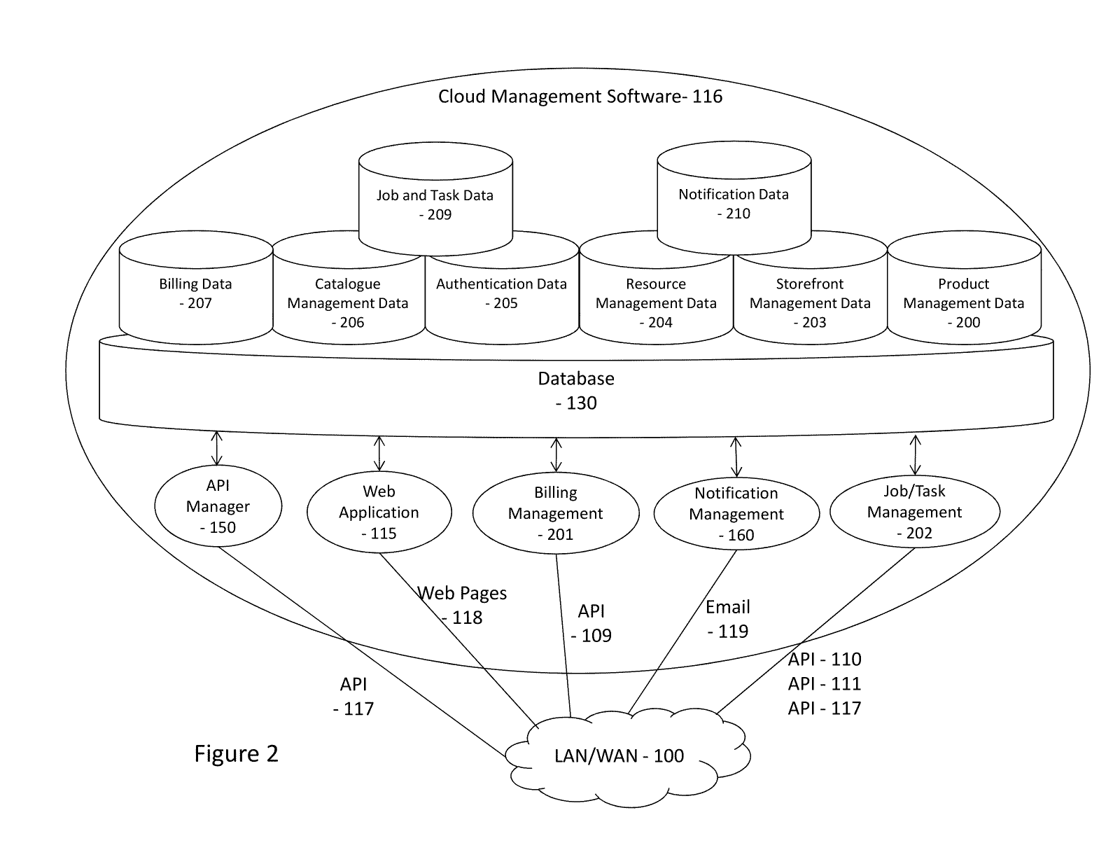

FIG. 2 shows more detail on the cloud management software 116. The job/task management software 202 is responsible for workflow and automation. For example customer orders could be a job that is made up of many tasks. The job/task management software 202 would be responsible for making sure all the tasks within the job are done. It uses API 110, API 111 for accomplishing some of the tasks. It also allows a third party provider 120 (shown in FIG. 1b) through the API manager 150 the ability to manage, change, access and configure the jobs and tasks via API 117.

The notification manager 160 is responsible for notifying partners 113 (shown in FIG. 1b) via for example email 119 whenever an event takes place that the partner 113 is interested in. An example of this could be when a credit card has been processed for payment. The billing management software 201 is responsible for invoices, billing hourly/monthly/quarterly transactions and payment processing. It uses payment applications 104 (shown in FIG. 1b) to do this via API 109. The database 130 used to hold all the information necessary to manage the partner 113 can further be broken into different categories for functions provided by the embodiment. This database 130 is used by the web application 115 (shown in FIG. 1b) for:
filling in the data displayed to the partner 113 via the web page viewer 114 (shown in FIG. 1b),
the billing management software 201,
the notification manager 160 for retrieving event notification information and partner 113 addresses, and
the job/task management software 202.
   Included in the database 130 is:
Billing data 207 used by billing management 201,
Catalogue management data 205 which is used to manage the partner's 113 raw apps and services 112 (shown in FIG. 1b) and the service provider's ownership 131 (shown in FIG. 1b) of raw underlying services used by the partner 113 to create a catalogue,
Authentication data 205 used to authenticate partners 113,
Resource management data 204 used to manage switches and routers 108 (shown in FIG. 1b) and virtualization software 107 resources,
Storefront management data 203 used to partner 113 branding, settings and storefront and
Product management data 200 which includes marketing material, pricing, and configuration used to manage partner's 113 product which is built around one or more catalogues.
Job and task data 209, which is used to define the jobs and tasks in the system.
Notification data 210, which is used for notifications.

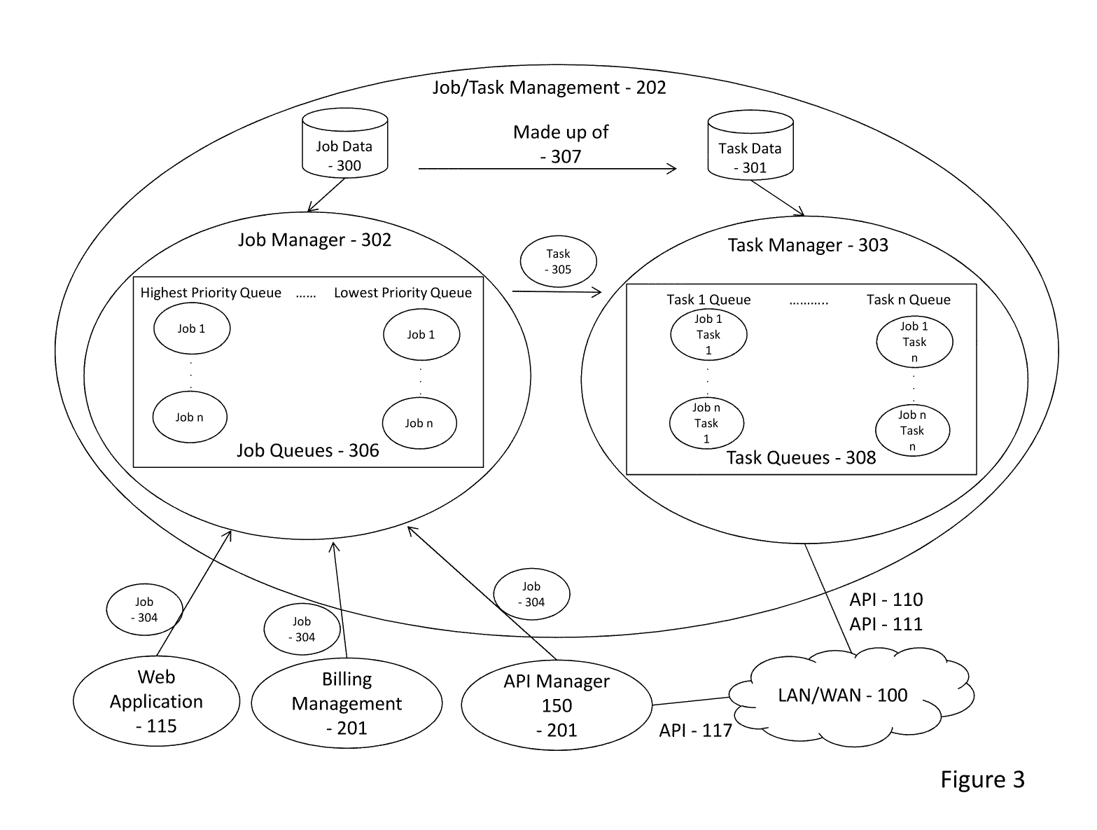

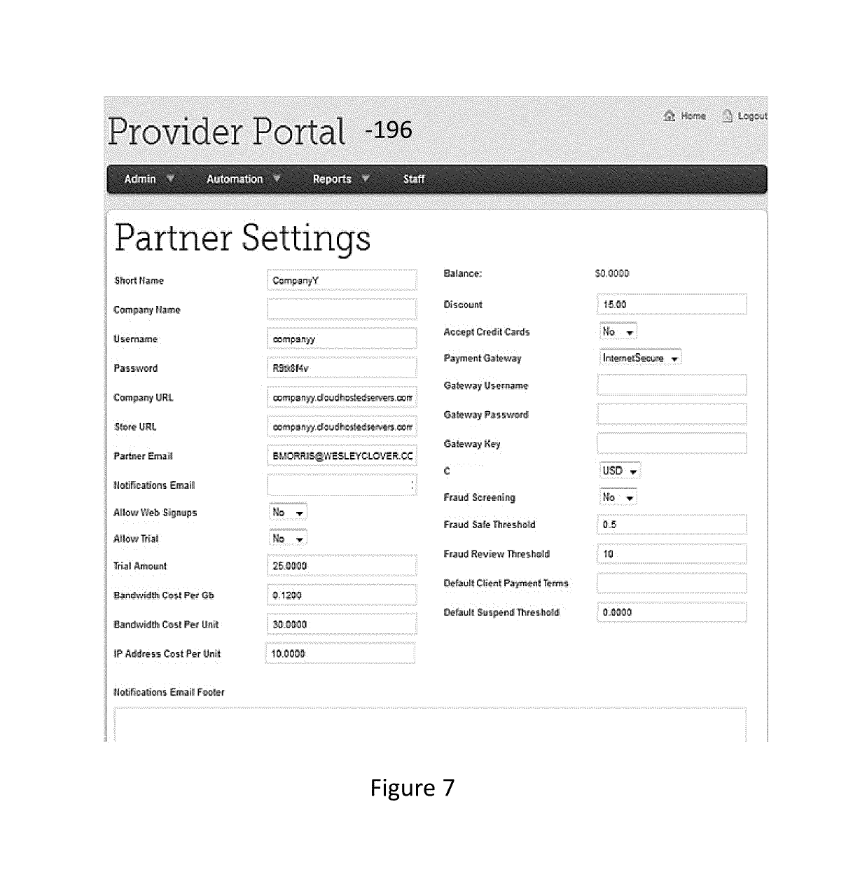

FIG. 3 shows task management 202 in more detail. Many jobs are defined in the system and stored in the job data 300. Any time a service provider 170, a partner 113 or client 140 commits on a web page (see FIGS. 7 to 34) the web application 115 adds a job 304 to the job queue 306. The job queues 306 are prioritized depending on the web page adding them, since some jobs 304 are more important or real time sensitive than others. Billing management 201 can also add jobs 304 to the job queue 306. Through API 117 third party providers 120 (shown in FIG. 1b) can add jobs 304 to the job queue 306.

The job manager 302 is responsible for managing the job queues 306 and the jobs 304 based on the job data 300. Jobs 304 defined by job data 300 are made up of 307 tasks 305 which are defined by task data 301. The job manager 302 builds the tasks 305 associated to the job 304. When the job manager 302 runs a job 304, it adds the tasks 305 that make up the job 304 to the task queues 308.

The task manager 303 is responsible for running all the tasks 305 in the task queues 306. Each type of task 305 has its own queue. Each task 305 knows how to communicate with external resources through APIs 110 and 111 in order to get the task 305 done. The job manager 302 and task manager 303 are multi-threaded. Because the tasks 305 are abstracted, if they need to change, or if new tasks 305 are added to the system, then the changes are isolated to the job manager 302 and task manager 303, the rest of the system is not affected.

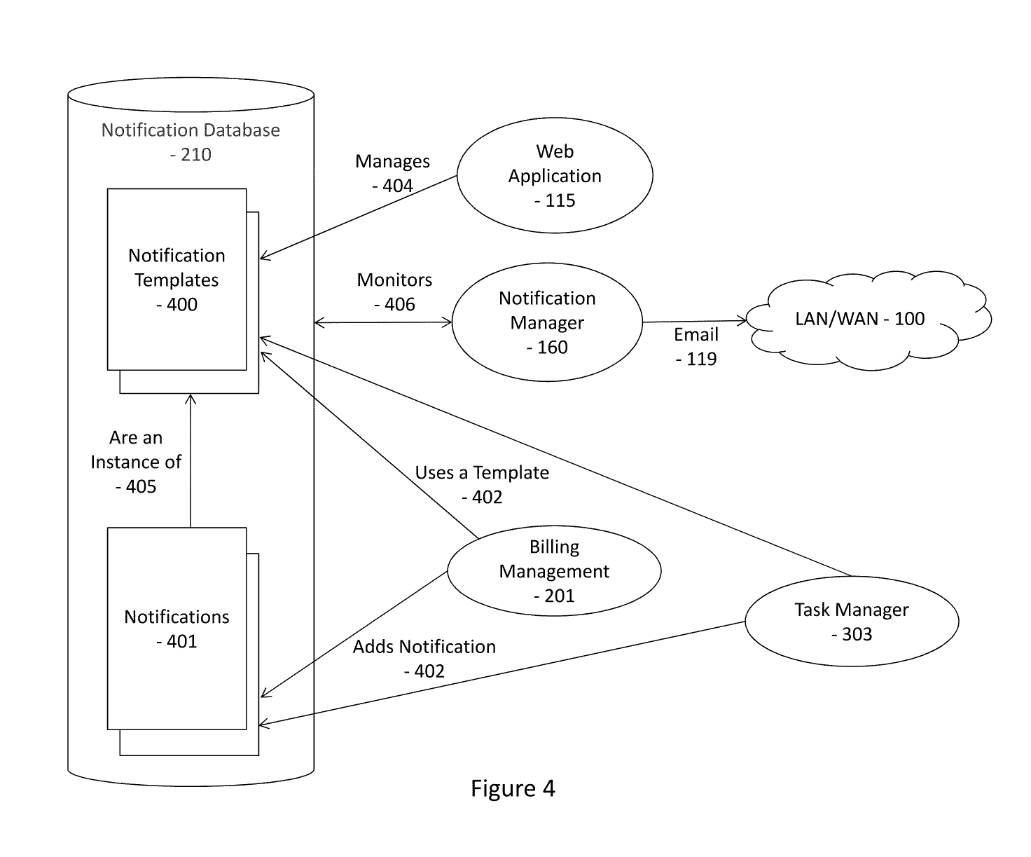

FIG. 4 shows how the notification manager 160 works. The notification data 210 is made up of notification templates 400 which define the notifications 401 sent out, and notifications 401 which are instances of 405 notification templates 400. The task manager 303 and billing management 201 both add notifications 402 to the notification data 210. They do this by using a template 402 and filing it with data. The notification manager 160 monitors 406 the notification data 210, and when a new notification 401 is added it is responsible for sending it out (for example and email 119). Other forms of notification are also possible, for example SMS messages or Twitter tweets. The web application 115 manages 404 the notification templates 400 through web pages 118 (shown in FIG. 1b).

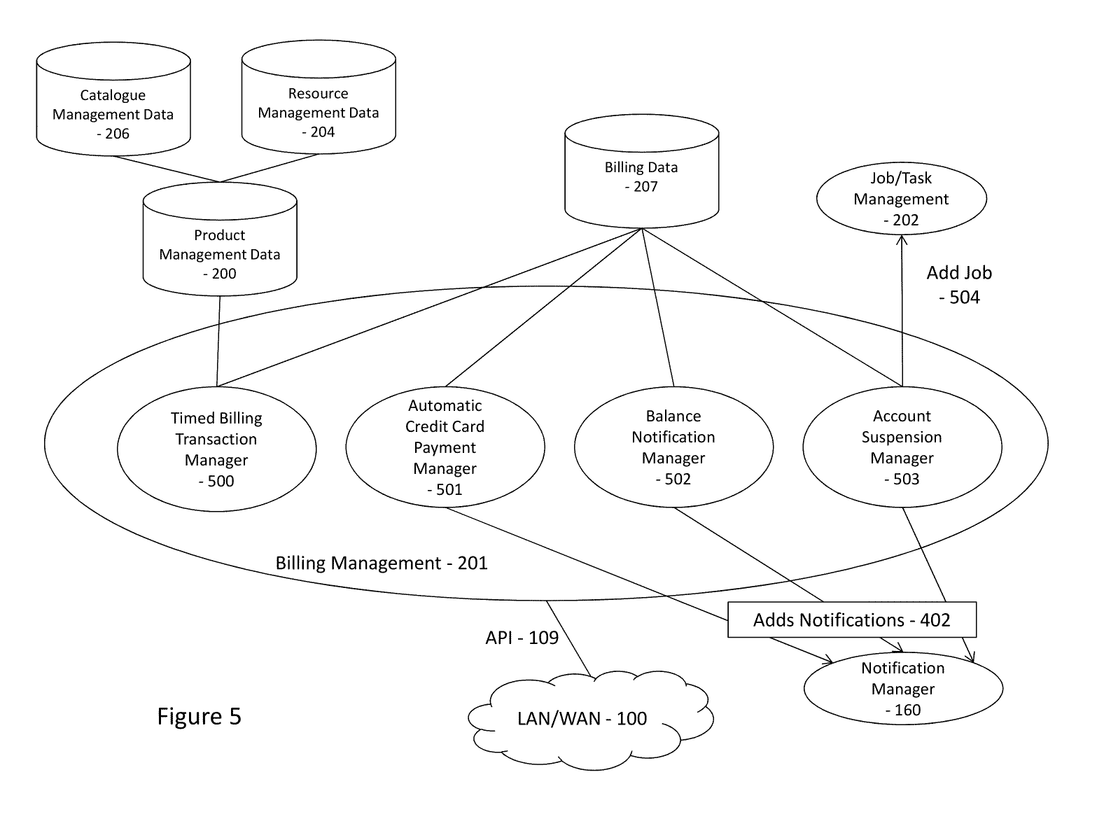

FIG. 5 further expands billing management 201. Billing management 201 is made up of the timed billing transaction manager 500, the automatic credit card payment manager 501 the balance notification manager 502 and the account suspension manager 503.

The timed billing transaction manager 500 gathers a list of partners 113 and subsequent clients 140 (shown in FIG. 1b) from the billing data 207. From that it gets a list of active products, the usage figures and the cost per unit of usage for each from the product management data 200 (which uses the catalogue management data 206 and resource management data 204 to get the information). The timed billing transaction manager 500 then computes the price per active product by multiplying the usage figure times the cost per unit and creates a transaction in the billing data 207 for the client 140. It also keeps a running total of all resources used by the clients 140 for the partner 113 which is stored as a transaction for the partner 113 in the billing data 207. It uses the notification manager 160 to add a notification 402 to send to the clients 140 and partners 113.

The client 140 can set up an automatic balance top up, for automatic payment for services, in which they pick a threshold for the balance, which when reached adds a programmable amount of money to their account. The automatic credit card payment manager 501 manages this and uses the notification manager 160 to add a notification 402 to send to the clients 140.

The balance notification manager 502 uses the notification manager to add a notification 402 about service time remaining to send to the clients 140.

The account suspension manager 503 monitors all the client 140 accounts, and if the $ amount goes below a certain threshold, then it suspends all services by adding a job 504 to the job/task management 202. It uses the notification manager 160 to add a notification 402 to send to the clients 140. It uses API 109 to process credit cards through the payment applications 104.

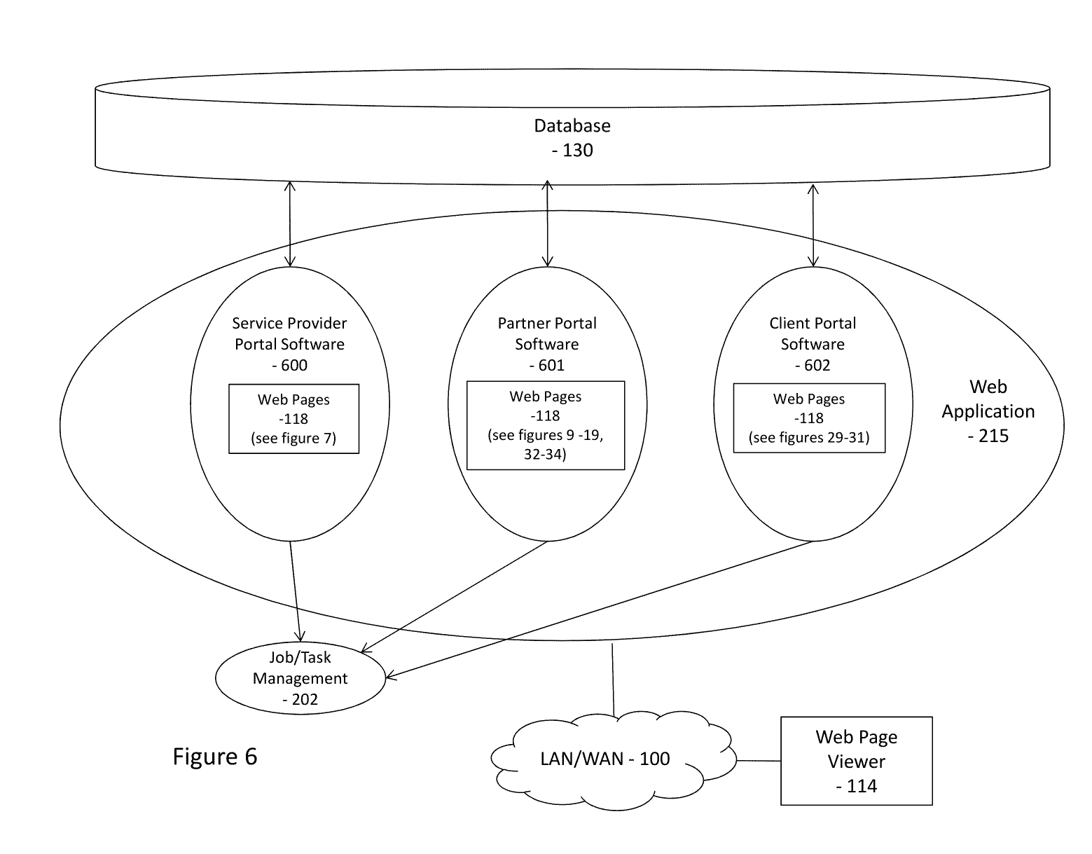

FIG. 6 shows how the web application 215 works. The database 130 is managed, viewed and consumed via software implementing three portals, the service provider portal software 600, the partner portal software 601 and the client portal software 602. The database stores a model vanilla storefront with configurable parameters so that it can be customized to the needs of individual partners. The storefront can be customized to show a partner's logo, types of products and services etc. By setting values of the configurable parameters the storefront can be fully customized to have the look and feel of a custom-designed website.

Web pages 118 are populated from the database 130 and viewed by a web page viewer 114. Users of the web page viewer 114 cause data to be written into database 130. The service provider 170 creates or assigns resources for the partner 113 to use via the service provider portal software 600, which causes jobs 304 to be sent to the job manager 302. The service provider 170 can also manage jobs 304 and tasks 305 through the service provider portal software 600. The partner 113 creates or assigns resources for the client 140 to use via the partner portal software 601, which causes jobs 304 to be sent to the job manager 302. The client 140 uses the client software portal 602 to buy a partner app or service 112.

FIGS. 7 to 34 show a step-by-step process of creating a new partner 113, allowing them access to the system, and then having them create a new client 140, and some of the screens associated with managing the new client 140.

FIG. 7 shows the service provider 170 portal 196 web page 118 for creating a partner account for Company Y. The service provider 170 fills in all the data and once they commit the form, a job 304 (shown in FIG. 3) is sent to create a new partner 113 and their data is stored in the database 130.

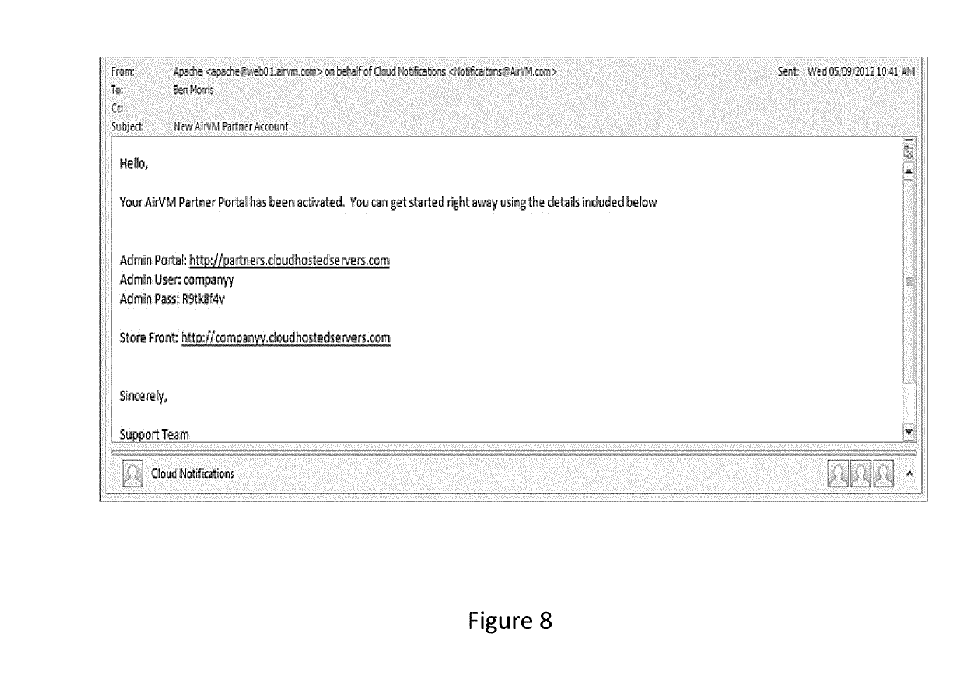

FIG. 8 shows an example email sent to the new partner 113 that gives them all the credentials for logging in and managing their new account and for example creating a new storefront.

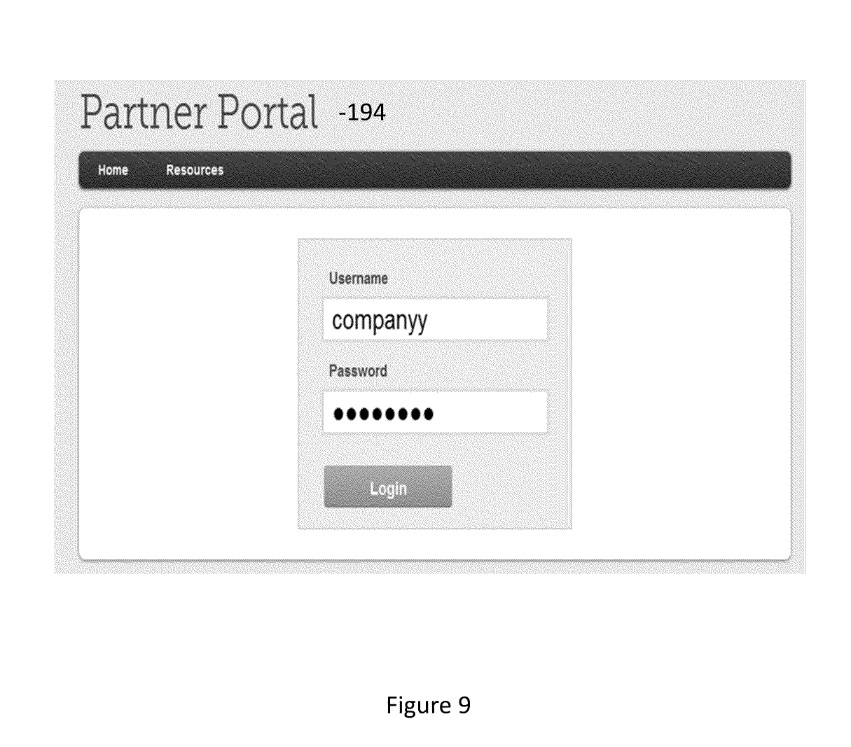

FIG. 9 shows the partner portal 194 web page 118 for logging in to their new account.

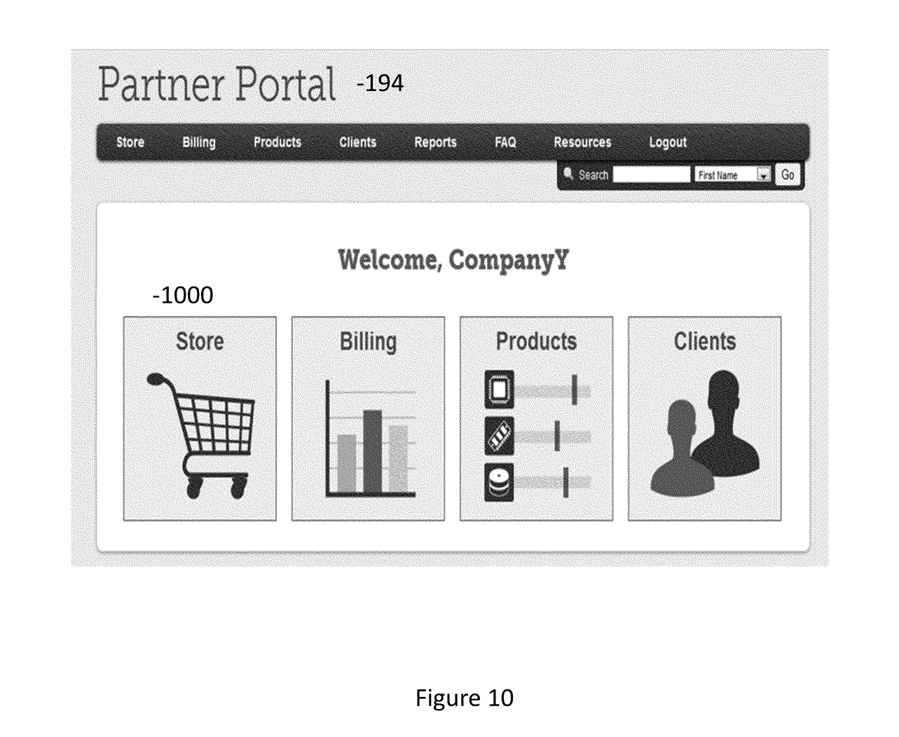

Once they log in FIG. 10 shows the next web page 118 in the partner portal 194. They click on store 1000 to create the catalogue of sellable apps or services 112.

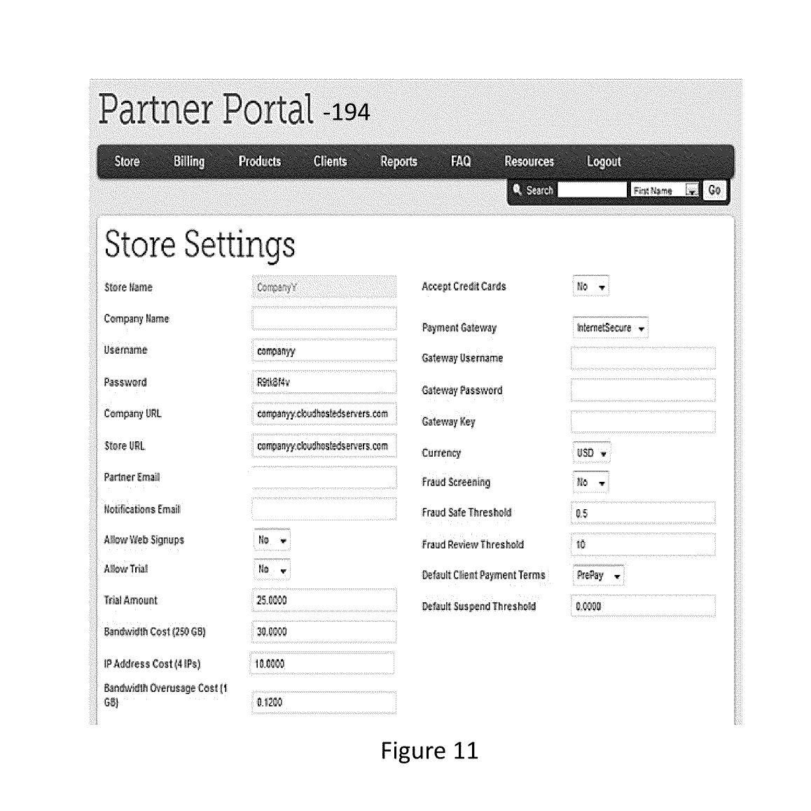

FIG. 11 shows the web page 118 for the partner 113 to configure their store through the partner portal 194. They add their online payment gateway settings, which are provided by the third party payment application 104 (shown in FIG. 1b) in the payment server 103 (shown in FIG. 1b) via API 109 (shown in FIG. 1b) (an example would be an Internet Payment Merchant like PayPal). Once this form is committed, the data is stored in database 130 and a job 304 is sent to configure the store and add their payment settings.

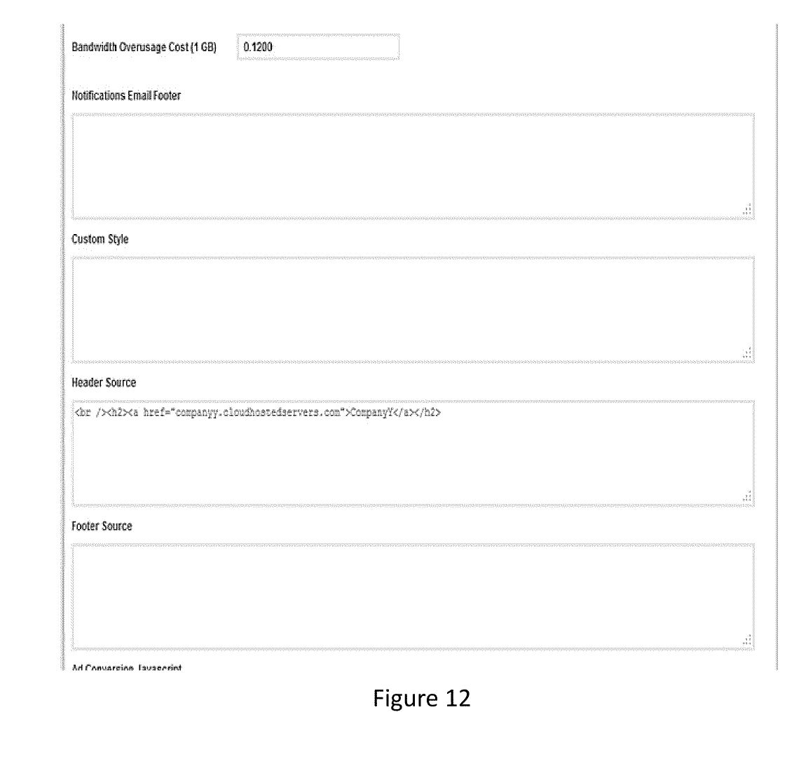

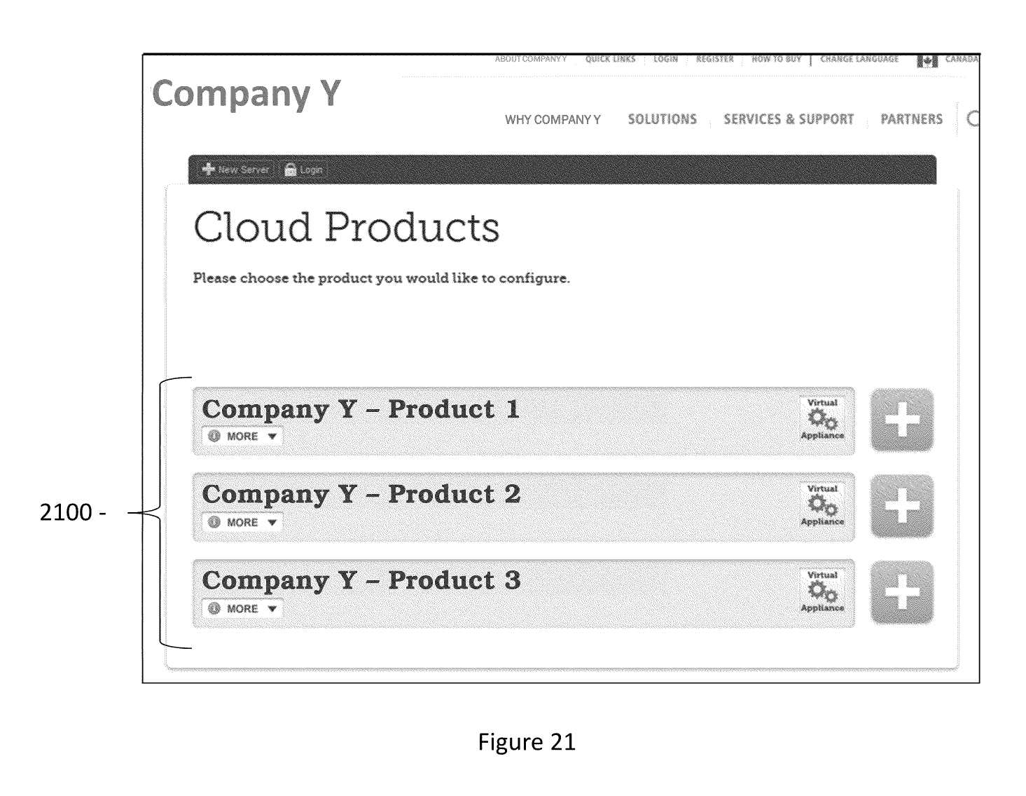

FIG. 12 shows more of the web page 118 for the partner 113 to configure their store. After configuring the online payment gateway the partner 113 also sets their store branding preferences. This allows the partner 113 to make the hosted storefront appear as if it is their own and hosted from their own site (see FIG. 21). Once this form is committed, the data is stored in database 130 and a job 304 is sent to set up the store branding.

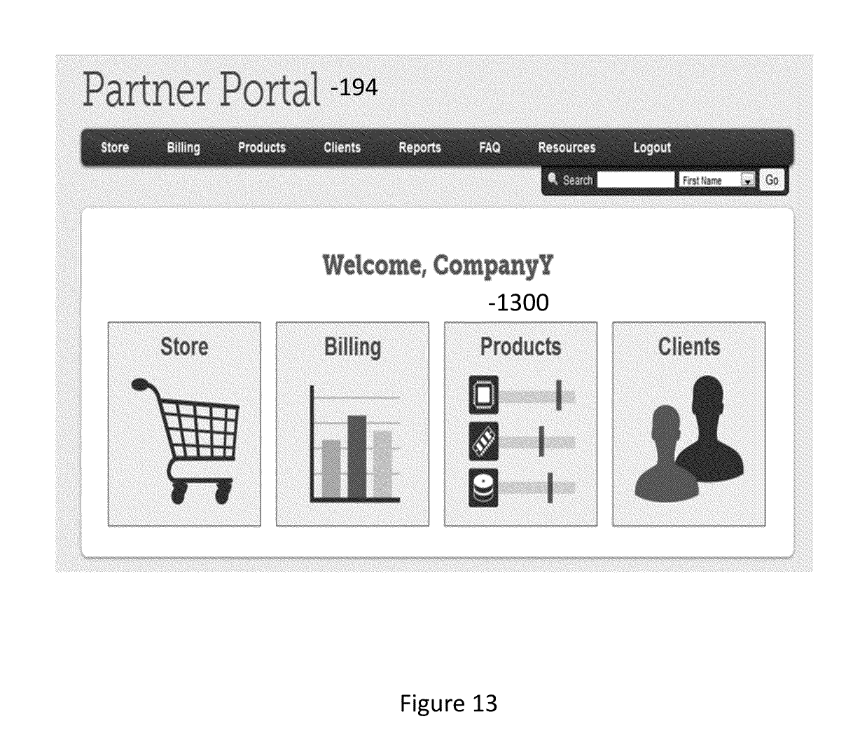

The partner 113 then wants to add a new product to the store. FIG. 13 shows the web page 118 in partner portal 194 to do this. They click on the products button 1300 to do this.

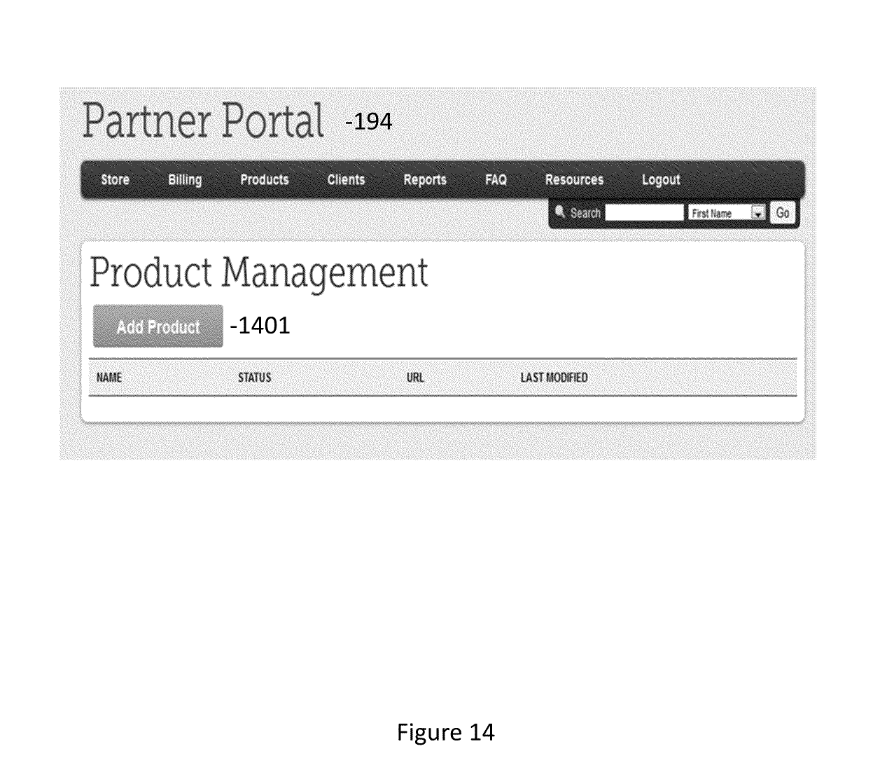

In FIG. 14 they click on add product 1301 to add products and build a catalogue.

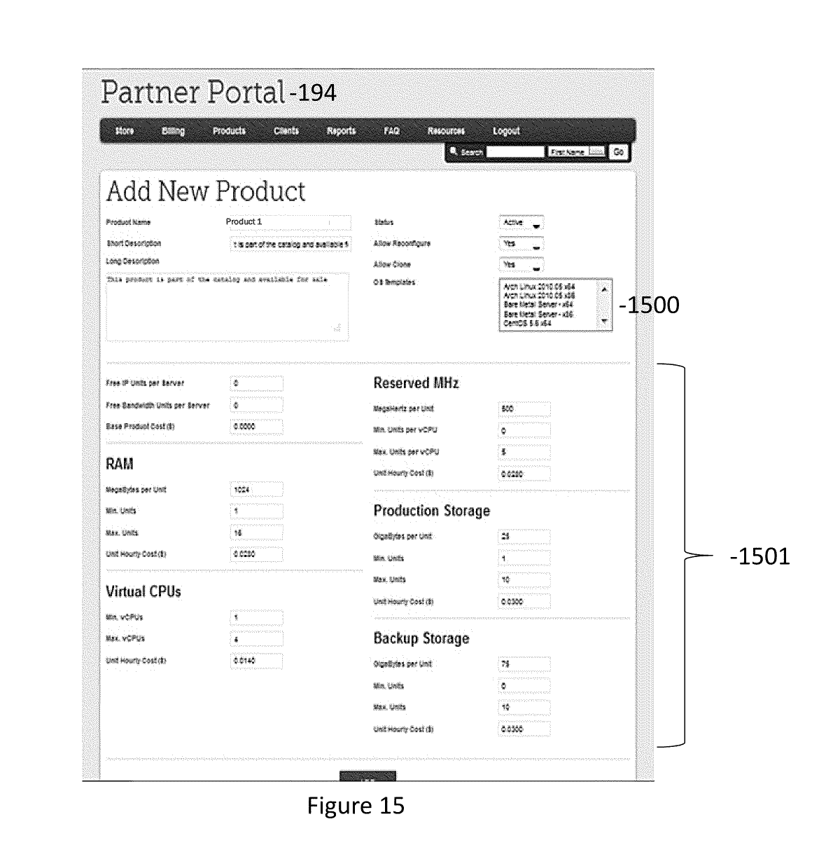

FIG. 15 shows the add product web page 118 which is part of the partner portal 194. They can create the product using an online template 1500, or they can build their own product by filling in the appropriate data 1501 (which then uses for example Vmware OVF and OVA files).

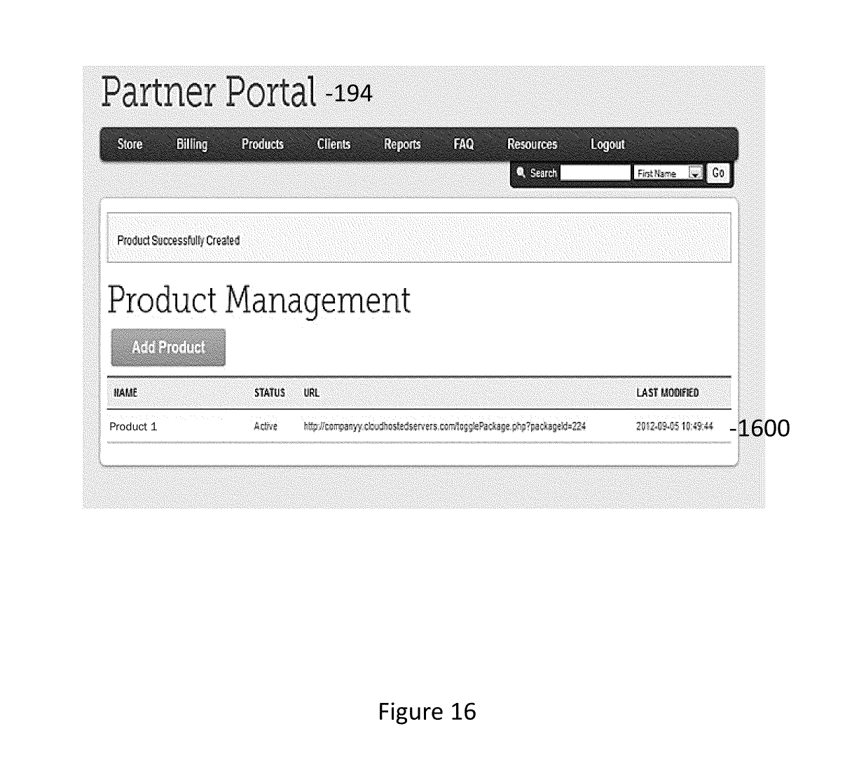

FIG. 16 now shows that the product has been created 1600 and is part of the catalogue.

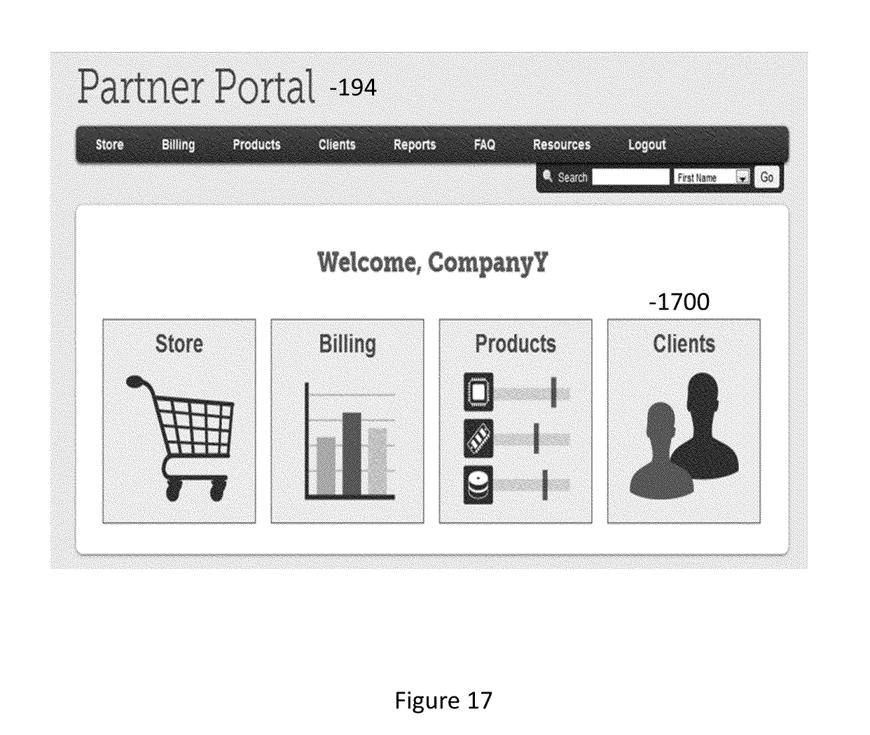

FIG. 17 shows that next the partner 113 wants to add clients 140 (shown in FIG. 1b). They go back to the partner portal 194 web page 118 where they can click on the client's button 1700 to add clients 140.

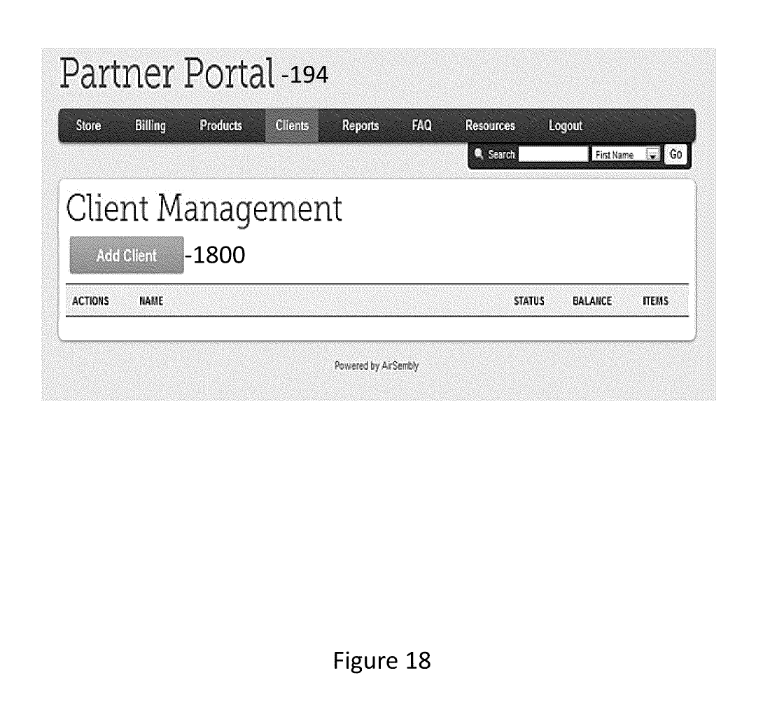

FIG. 18 shows the client management web page 118 in the partner portal 194. The partner 113 adds clients 140 by clicking on the add client button 1800.

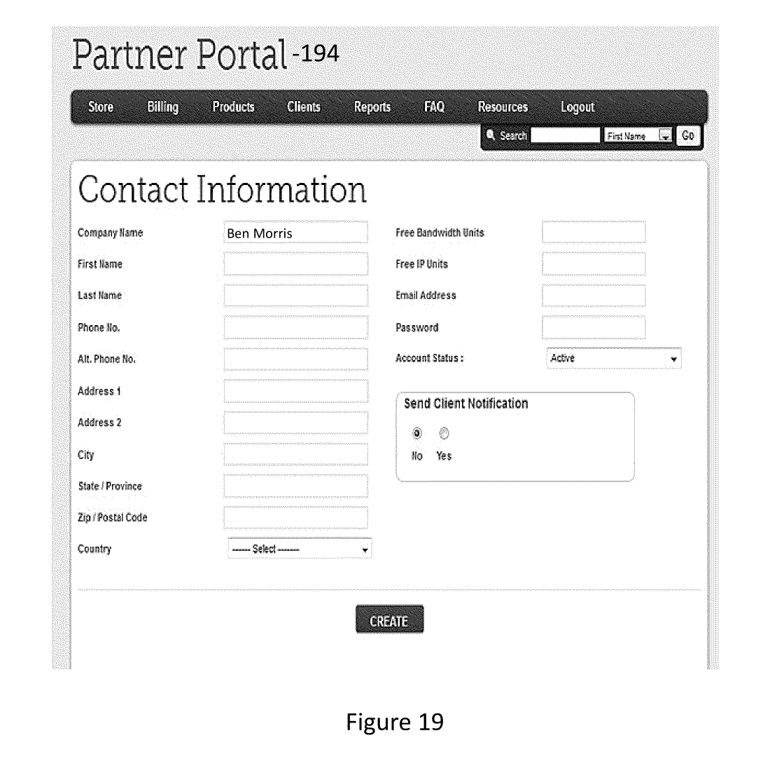

FIG. 19 shows the client 140 configuration web page 118 for the partner portal 194. When committed, it adds the information to database 130 and starts a job 304 to create the client account. Details including login information are emailed to client 140 via the notification manager 160.

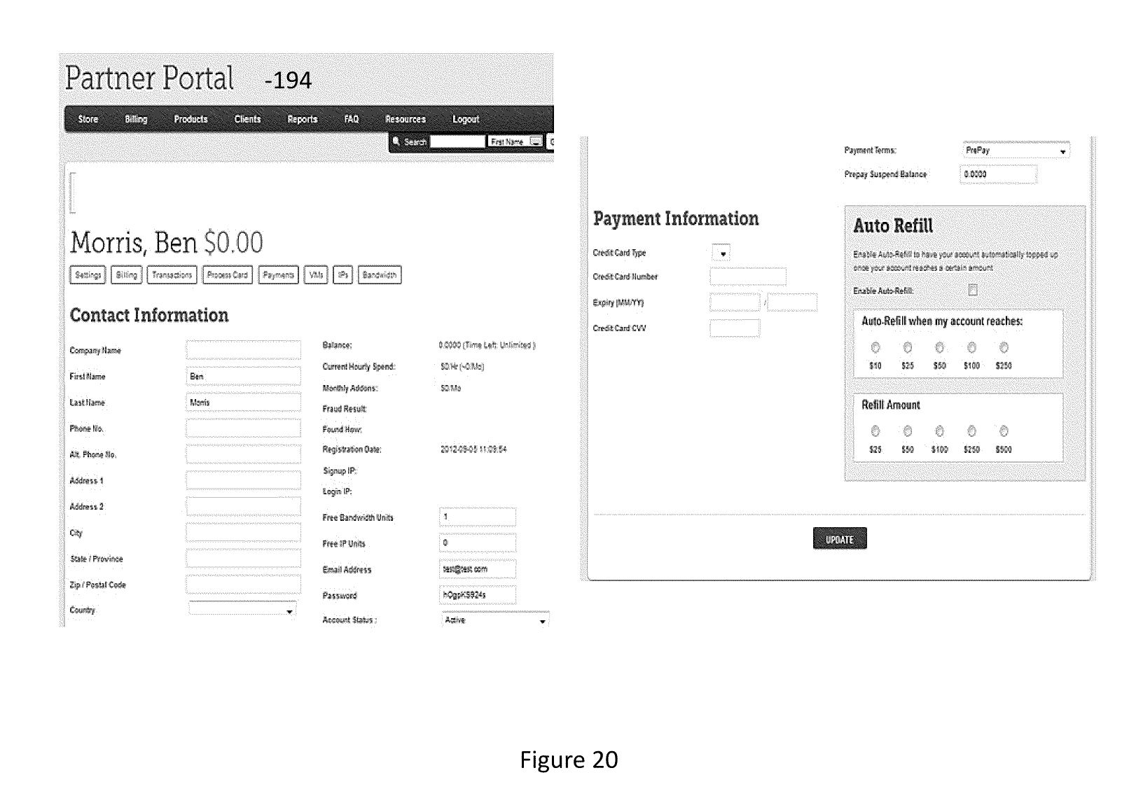

FIG. 20 shows the client 140 now has a client portal 602 which has a dashboard which shows account activity including additional client self service functions: settings, billing, transaction, credit card processing, payment schedule, active apps or services 112, IP address allocation and amount of bandwidth used.

FIG. 21 shows the web page 118 seen when a client 140 browses to the store (companyy.cloudhostedservers.com) where they see the products 2100 available for sale which are part of the client portal software 602.

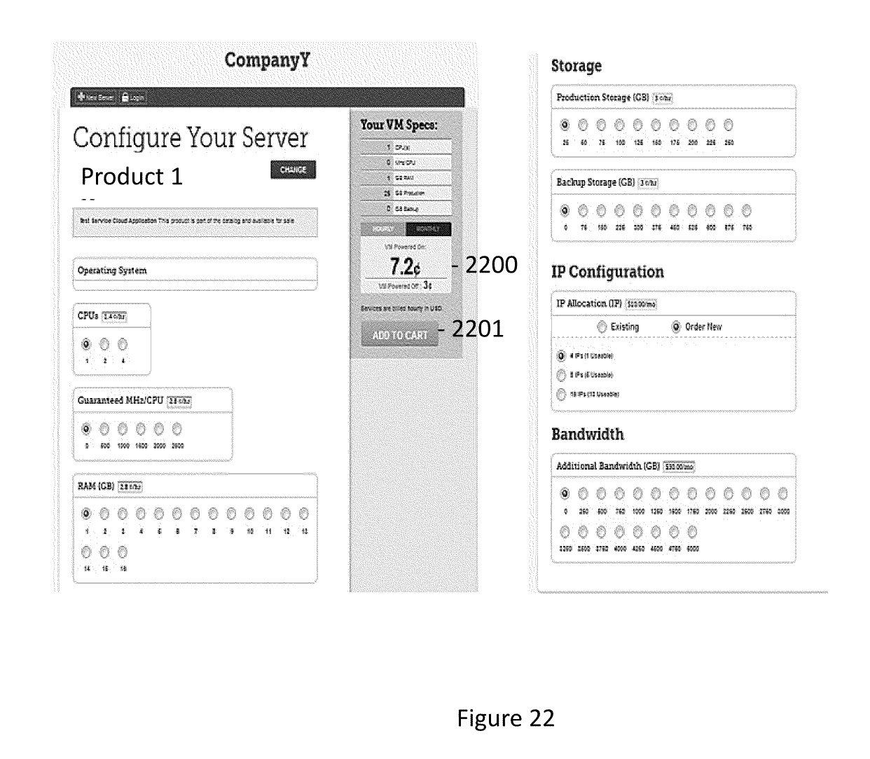

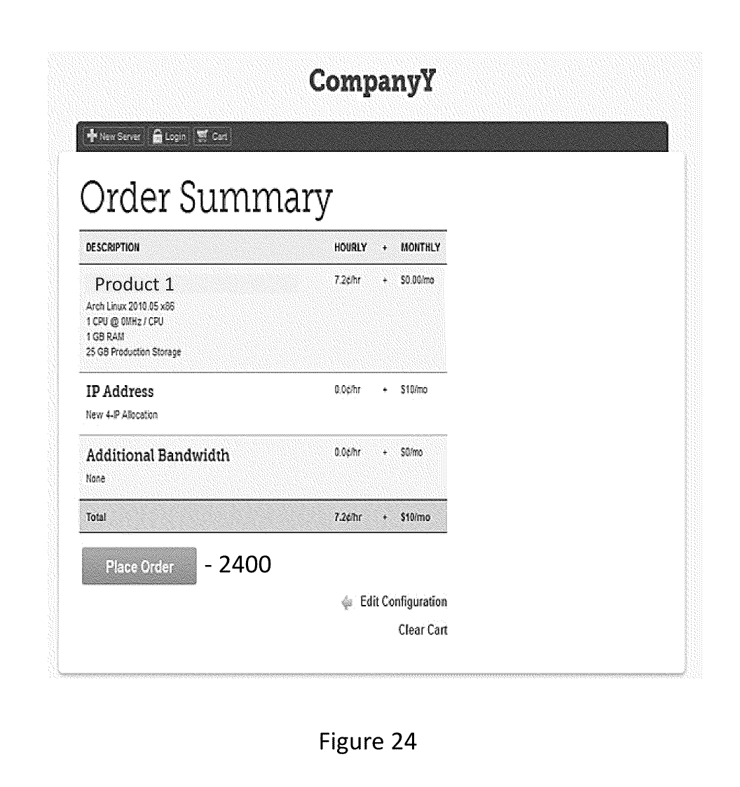

FIG. 22 shows what happens when the client 140 clicks on a product 2100 available for sale. When the client 140 selects the product 2100 they have some configuration choices available. A real-time cost of the product is shown in amount per hours 2200. Once the client 140 is done they click on add to cart 2201 (see FIG. 24).

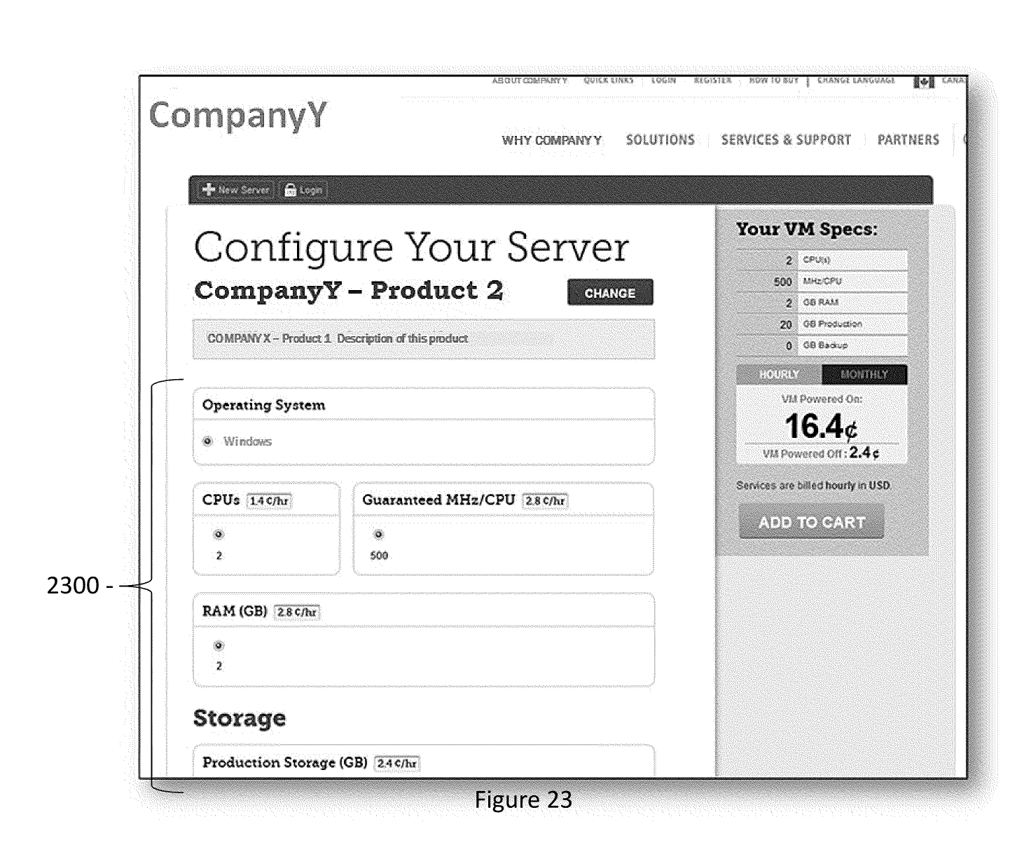

FIG. 23 shows a case (for product 2) where the optional selections may be minimized 2300 to make it simple for client 140 and to guarantee a quality of service that the original app/service 112 developer requires.

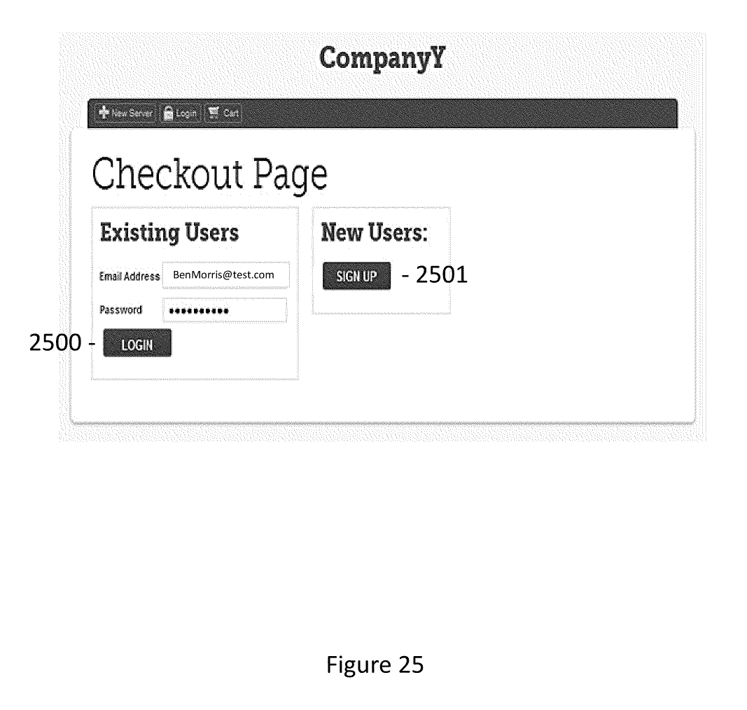

FIG. 24 shows the web page 118 shown once the add to cart 2201 button is pressed. When the client 140 clicks on place order 2400 it goes to the client 140 log in web page 118 (see FIG. 25) or the order is placed if the client 140 is already logged in.

FIG. 25 shows the client 140 log in web page 118 which authorizes the payment to be made and when successfully logged in 2500, the web application 115 stores the data in database 130 and adds a job 304 to the job manager 302 to process the buying of the new product 2100. New users can do a self serve sign-up 2501 by clicking the button.

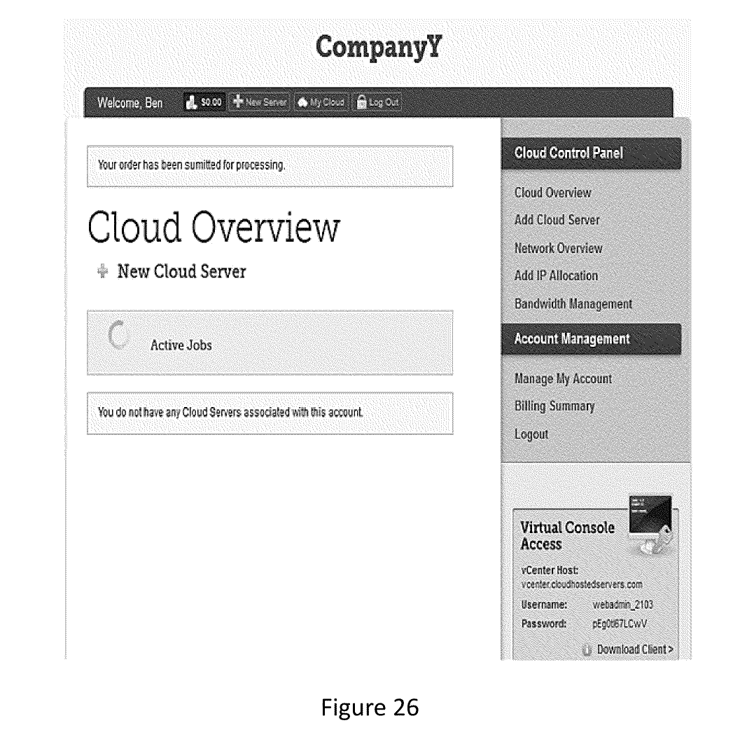

FIG. 26 shows the web page 118 after the client 140 successfully logs in. Upon client 140 payment completion, the virtual machine on the base server 105 is created using virtualization software 107 and the partner application or service 112 is deployed and associated to client 140. In some cases the service or application 112 is (1) licensed in an automated way via the partner 113 platform or (2) a script is run behind the scenes to provision the service or application 112 or (3) the service or application 112 is loaded and when first run by the client 140 a license must be input.

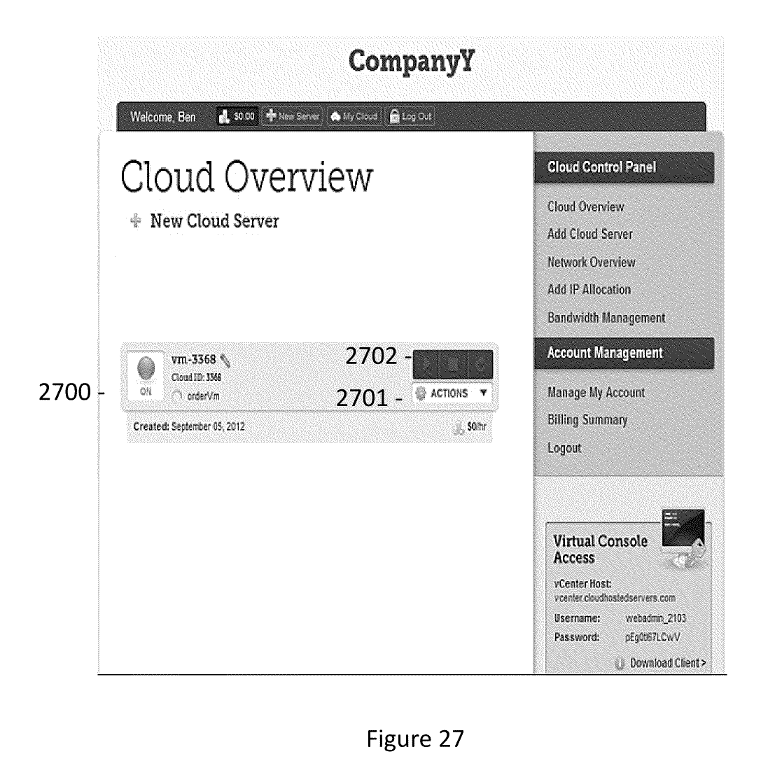

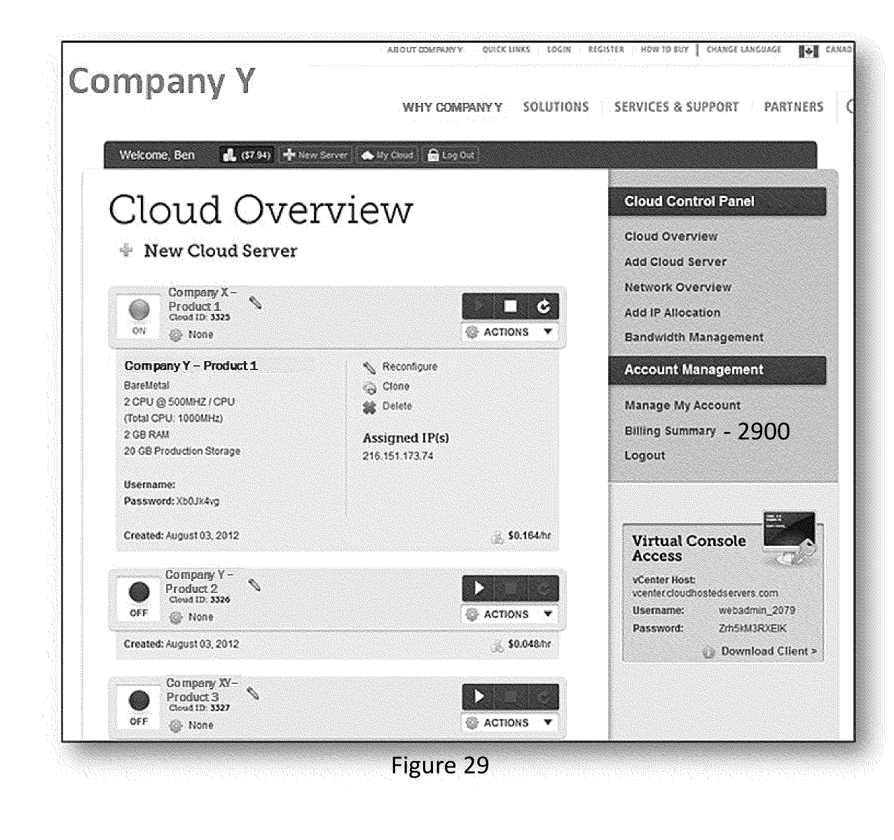

FIG. 27 shows that after a time period the virtual machine on the base server 105 which is running the app or service 112 is ready and shown as running 2700. Through this page the client 140 has the ability to add CPU/RAM/HDD resources on the fly via the actions button 2701, which is also unique to this embodiment (see more detail FIG. 29). The client 140 can also pause their instance of the partner app or service 112 in the event it is no longer needed. In this case the pricing model changes (to a nominal amount), the image of the client instance of the partner app or service 112 is kept in storage and can be activated at a moment's notice by pressing the Play button 2702. From this menu the client can also clone the partner app or service 112 to expedite additional images.

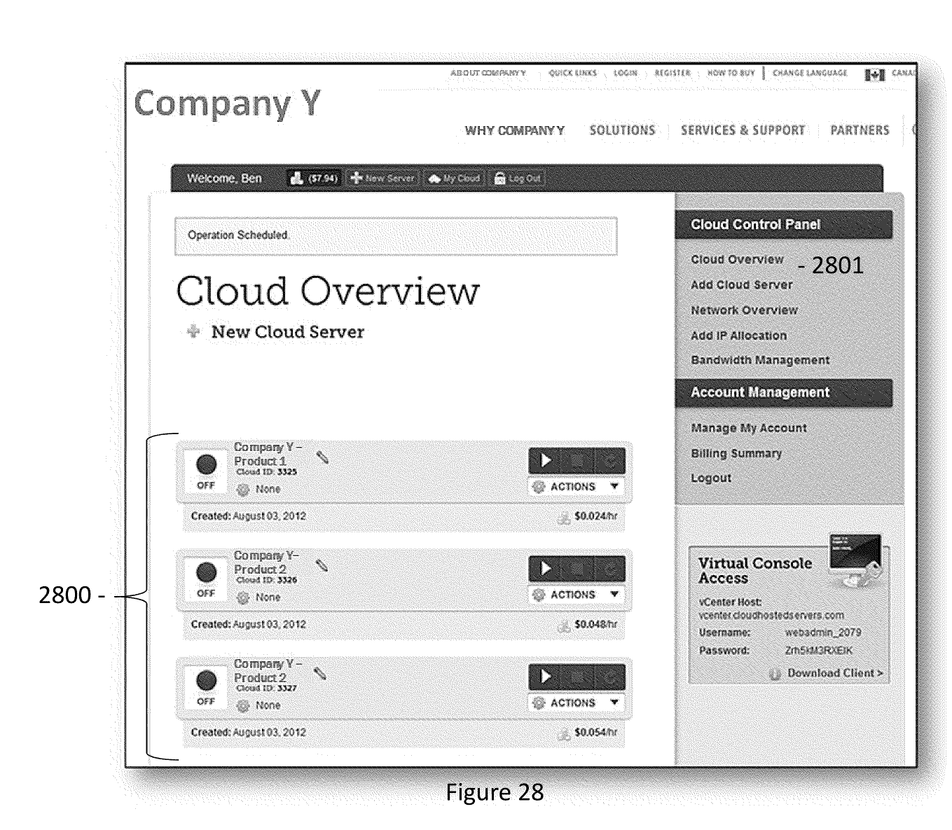

FIG. 28 shows an example of a list 2800 of all active partner apps or services 112 under the client 140 profile. This is seen when the cloud overview button 2801 is clicked. As shown, there can be more than one instance of the same product running.

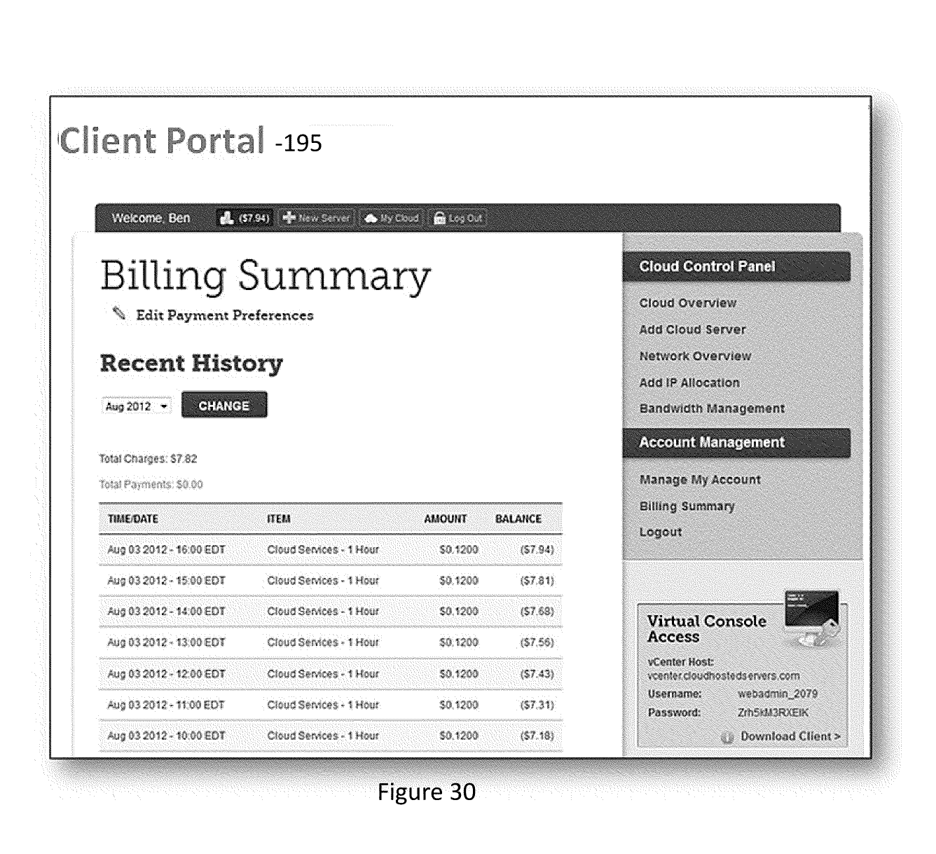

FIG. 29 shows the details of the first active partner app or service 112 for the client 140. Clicking on billing summary 2900 gets the client 140 to FIG. 30.

FIG. 30 is a web page 118 for client portal 602 that shows a timed billing summary for all partner apps or services 112 for the client 140 account (this is also available at a higher level for the service vendor 113).

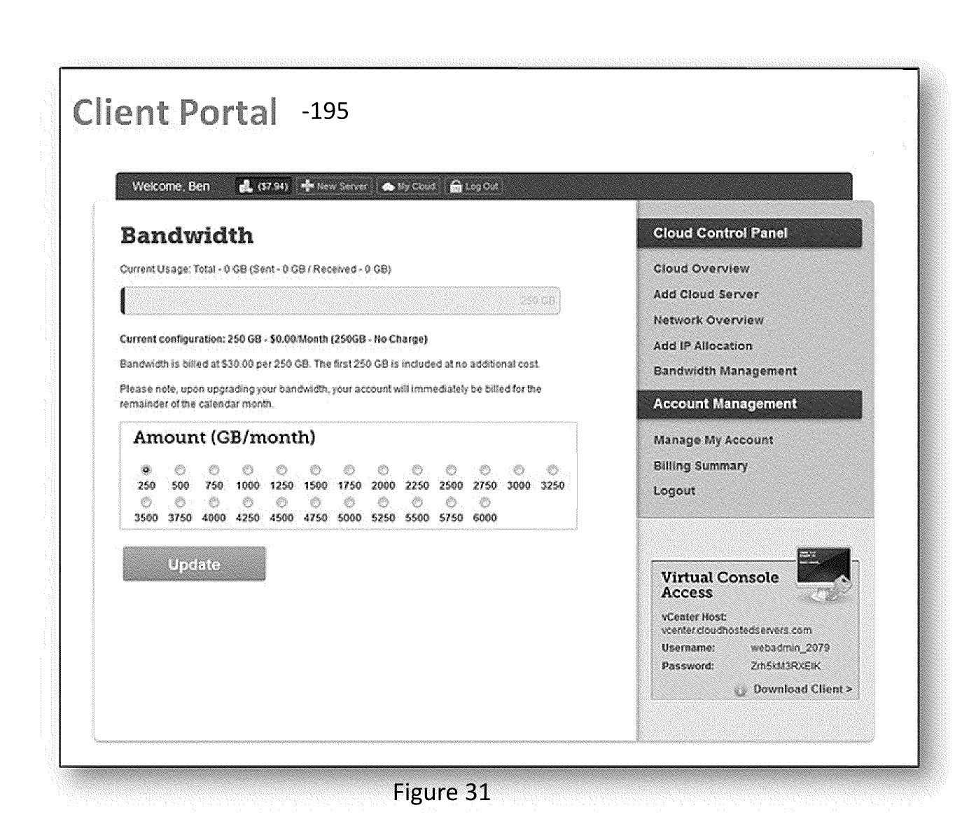

FIG. 31 is a web page 118 for client portal 602 that shows bandwidth details for specific or a sum total for all of the client 140 partner apps or services 112.

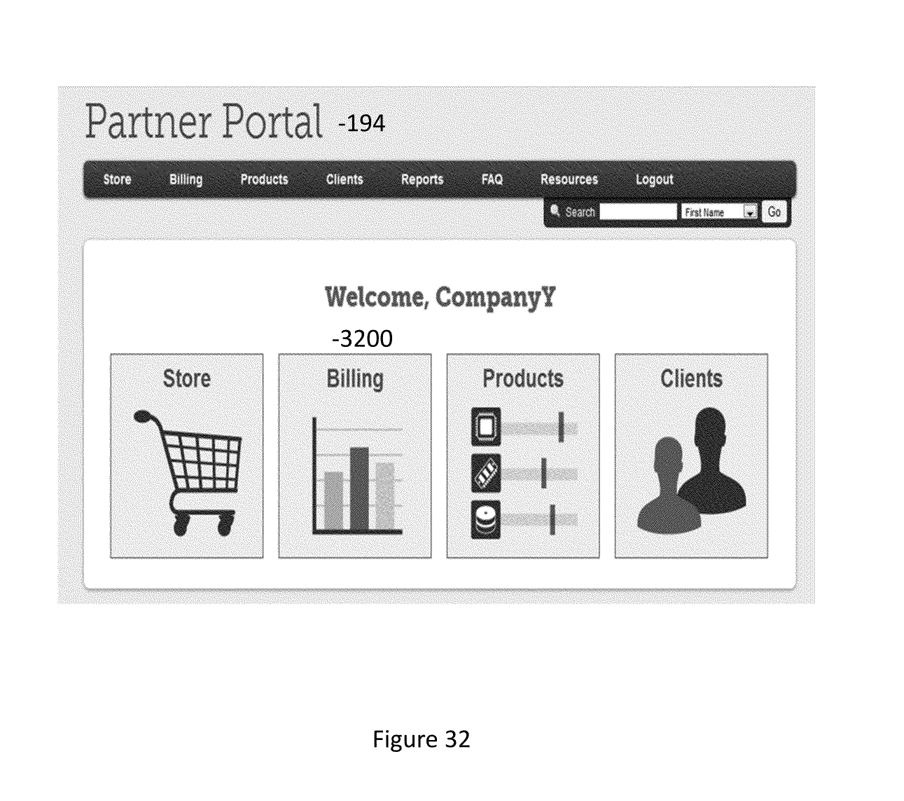

FIG. 32 is back at the partner portal 194 after the partner 113 logs in. They click on billing 3200 to see reports on all their clients 140.

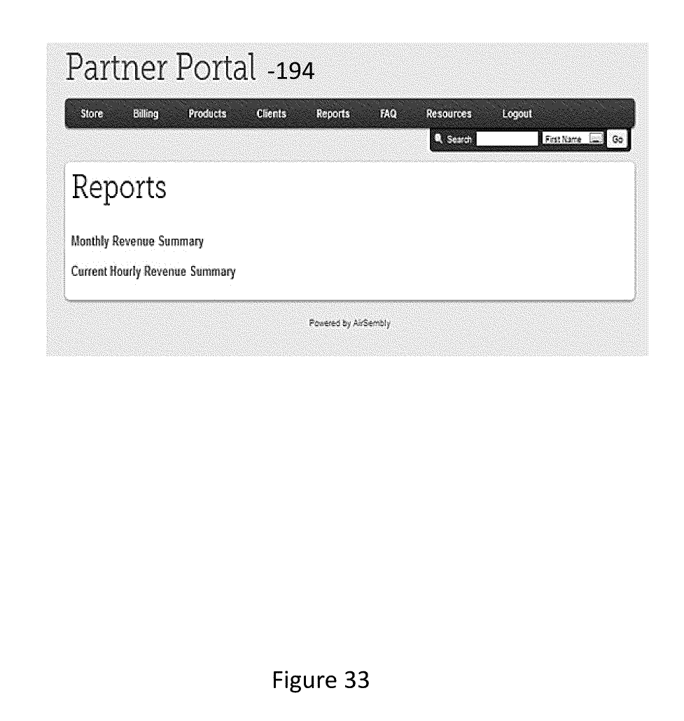

FIG. 33 shows the web page 118 for the partner portal 194 that shows the partner 113 can see all of their clients 140. Billing and revenue details are provided at the highest level for the partner 113.

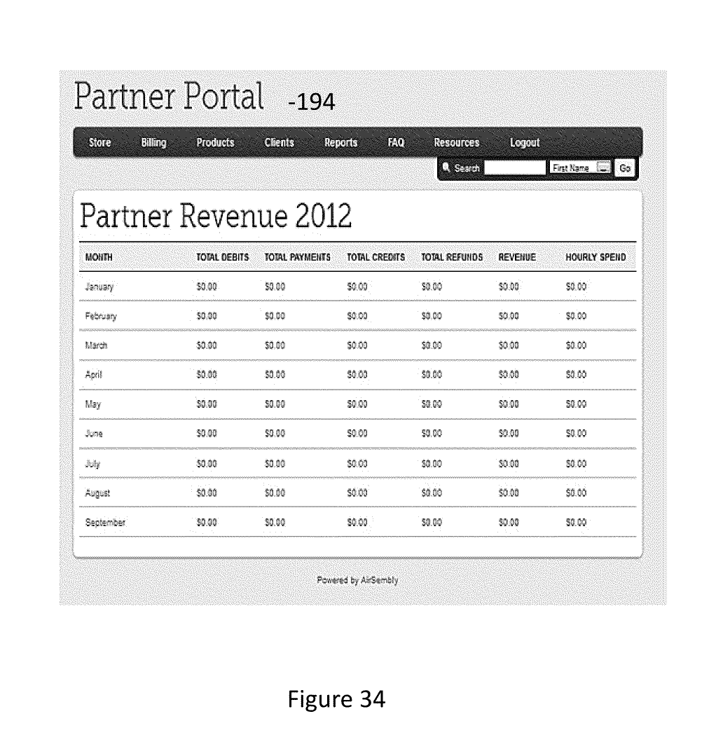

FIG. 34 shows the web page 118 for the partner portal 194 that shows the sum total of all the client 140 details.

It will thus be seen that the invention provides distribution chain whereby the distribution of products and services is performed through distributors operating in a cloud environment.

It should be appreciated by those skilled in the art that any block diagrams herein represent conceptual views of illustrative circuitry embodying the principles of the invention. For example, a processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. The functional blocks illustrated herein may in practice be implemented in hardware or software.

1. A virtualized distribution system for offering virtual products or services to clients over a distributed network, comprising:
physical resources managed by a service provider; and
one or more orchestration servers having access to the physical resources and being configured to run cloud management software to:
(i) maintain a service provider portal to permit the service provider to manage the physical resources and accounts for distribution partners,
(ii) maintain a partner portal to permit the distribution partners to create virtual products or services using the available physical resources and establish a virtual presence on said distributed network, and
(iii) maintain a client portal for offering to clients the virtual products or services created by the distribution partners through their virtual presence.

2. A system as claimed in claim 1, wherein the service provider portal is configured to permit the service provider to create new accounts for distribution partners.

3. A system as claimed in claim 2, wherein the partner portal is configured to permit new distribution partners to self-create distribution partner accounts by logging in to the partner portal.

4. A system as claimed in claim 1, wherein the orchestration server is configured to create multiple portals for a hierarchy of distribution partners such that senior distribution partners define an environment for junior distribution partners in the hierarchy.

5. A system as claimed in claim 1, wherein the virtual resources are implemented as instantiations of virtual machines within the physical resources.

6. A system as claimed in claim 1, wherein the cloud management software includes at least one web application communicating with the database for maintaining the service provider portals, the partner portals, and the client portals.

7. A system as claimed in claim 1, further comprising a database storing a model storefront with configurable parameters, and the partner portal presents a web page with fields accepting values for the configurable parameters, whereby in response to entry of the configurable parameters the web application creates a customized storefront for the partner accessible through the client portal.

8. A system as claimed in claim 1, wherein the cloud management software includes a job/task manager for controlling the operation of the system by prioritizing and performing tasks to implement the system.

9. A system as claimed in claim 1, further comprising at least one business management application for providing business services to the portals.

10. A system as claimed in claim 9, wherein the at least one business management application is a payment processing application for processing payments from clients for products or services purchased through the client portals.

11. A system as claimed in claim 9, wherein the at least one business management application is a product management application for automating the assembly of products or services.

12. A system as claimed in claim 9, wherein said at least one business management application comprising a billing engine for creating a billing report on usage and transactions for the clients, service providers or partners for products or services used.

13. A system as claimed in claim 12, wherein the billing engine is configured to enforce billing logic for different partner tiers.

14. A system as claimed in claim 1, wherein the orchestration server includes a notification manager for providing notifications to clients, service providers or partners pertaining to business management.

15. A system as claimed in claim 1, further comprising a database storing at least billing data, storefront management data for determining the storefront environment, and product management data pertaining to the products or services for sale.

16. A system as claimed in claim 1, further comprising an API associated with the orchestration server to permit third parties to build their own applications that interface directly with the system.

17. A non-transient computer readable medium storing instructions providing cloud management software that when run on an orchestration server having access to physical resources managed by a service provider causes the orchestration server to:
(i) maintain a service provider portal to permit the service provider to manage the physical resources and accounts for distribution partners,
(ii) maintain a partner portal to permit the distribution partners to create virtual products or services using the available physical resources and establish a virtual presence on said distributed network, and
(iii) maintain a client portal for offering to clients the virtual products or services created by the distribution partners through their virtual presence.

18. A computer readable medium as claimed in claim 17, wherein the service provider portal permits the service provider to create new accounts for distribution partners.

19. A computer readable medium as claimed in claim 18, wherein the partner portal permits new distribution partners to self-create distribution partner accounts by logging in to the partner portal.

20. A computer readable medium as claimed in claim 17, wherein the orchestration server creates multiple portals for a hierarchy of distribution partners such that senior distribution partners define an environment for junior distribution partners in the hierarchy.

21. A computer readable medium as claimed in claim 17, wherein the virtual resources are implemented as instantiations of virtual machines within the physical resources.

22. A computer readable medium as claimed in claim 17, wherein the cloud management software includes at least one web application communicating with the database for maintaining the service provider portals, the partner portals, and the client portals.

23. A computer readable medium as claimed in claim 17, wherein the partner portal presents a web page with fields accepting values for the configurable parameters, whereby in response to entry of the configurable parameters the web application creates a customized storefront for the partner accessible through the client portal from a stored model storefront.

24. A computer readable medium as claimed in claim 17, wherein the cloud management software includes a job/task manager for controlling the operation of the system by prioritizing and performing tasks to implement the system.

25. A computer readable medium as claimed in claim 17, wherein cloud management software communicates with at least one business management application for providing business services to the portals.

26. A computer readable medium as claimed in claim 25, wherein the at least one business management application is a payment processing application for processing payments from clients for products or services purchased through the client portals.

27. A computer readable medium as claimed in claim 25, wherein the at least one business management application is a product management application for automating the assembly of products or services.

28. A computer readable medium as claimed in claim 25, wherein said at least one business management application comprising a billing engine for creating a billing report on usage and transactions for the clients, service providers or partners for products or services used.

29. A computer readable medium as claimed in claim 17, wherein the cloud management software provides an API associated with the orchestration server to permit third parties to build their own applications that interface directly with the system.
